(19) United States
(12) Patent Application Publication
(10) Pub. No.: US 2005/0035964 A1
(43) Pub. Date: Feb. 17, 2005

(54) Multi-level hex mapping method

(76) Inventor: Phillip J. Heenan, Austin, TX (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/701,842

(22) Filed: Nov. 5, 2003

Related U.S. Application Data
(60) Provisional application No. 60/423,735, filed on Nov. 5, 2002.

(51) Int. Cl. G06T 17/00

(52) U.S. Cl. 345/420

(57) ABSTRACT

A method for enabling hexagon grid maps to have variable scale with varying levels of map detail at different map scales is disclosed. The Multi-Level Hex Mapping Method divides hexes of any given size into a number of smaller hexes and defines how the smaller micro-hexes relate to the larger parent hexes. Each different hex size defines a hex level or different scale in the map, thus providing variable scaling to hexagon-based maps. Various mapping attributes may be assigned to selected hexes and micro-hexes, such as terrain data and types. In addition, the method provides a layering mechanism to enable one or more layered attributes, such as tunnels, roadways, buildings, etc. to be associated with selected hexes. The method may be implemented either by the use of computer software or traditional hardcopy maps.

### RELATED APPLICATIONS

The present application is based on a co-pending provisional application entitled “MULTI-LEVEL HEX MAPPING METHOD,” Ser. No. 60/423,735, filed on Nov. 5, 2002, the benefit of the filing date of which is claimed under 35 U.S.C. § 119(e).

### FIELD OF THE INVENTION

The field of invention relates generally to maps and computer gaming and, more specifically but not exclusively relates to a method for building maps and mapping applications using multi-level hex mapping.

### BACKGROUND INFORMATION

Hexagons, or hexes as they are more commonly referred to, have traditionally been used to define locations on maps for war and other games, including computer-based games and board games. As shown in FIG. 1, a conventional map 10 includes a plurality of equally-sized hexes 12, wherein each hex defines a discrete location on the map. In addition, each of hexes 12 is assigned a type of terrain, represented by a symbol 14. Hexes are also used to calculate distances across a map by counting the minimum number of hexes from one hex location to another. Therefore a hexagonal grid system has traditionally been used as a means of representing maps for use in games by providing a grid-like structure that aids in the conceptualisation and execution of movement, placement, and combat across a map.

Hexes are traditionally a constant size within a given game, and the scale of the map is defined by the nominated hex size. For example, a map may be 40 hexes by 40 hexes, and the hex size may be nominated as 500 metres, in which case the map covers an area 20 kilometres by 20 kilometres. Each hex then represents an area 500 metres across and is hexagonal in shape.

Traditionally locations within a hex are not defined. Objects on the map are simply within one hex or another hex, with each objects location defined solely by the hex that it is in. Furthermore, different locations within a hex are not defined with the traditional hex mapping system.

The terrain within each hex is constant across the entire hex. Terrain can be defined as forest, open, fields, buildings, or whatever types of terrain are being modeled for the purposes of game. Traditionally terrain type only changes at a border 16 of a hex, although there can be specific linear type terrain objects (such as walls or gullies) located along one or more edges of a hex. Anything located within the hex is defined as being in the type of terrain that the hex contains. For example, a 500 metre hex that is covered by forest has forest covering the full area of the hex.

The terrain type within each hex 12 is usually displayed by some symbol 14 within the hex, often comprising a graphical representation of the terrain. In FIG. 1, each respective terrain type is represented by a corresponding letter, as shown in a legend 18. The letters are used for simplicity in FIG. 1; traditionally, graphical symbols are used to define terrain features both within hexes 12 and along hex edges 16.

Terrain elevation above a datum level can also be defined for each hex, with contour lines showing the hex edges 16, where levels change from a hex to an adjoining hex, in a similar manner to contour lines on conventional topographic maps. However, contour lines on hex based maps can only occur along hex boundaries 16, as the entire area within a traditional hex is defined as being at a constant elevation.

### SUMMARY OF THE INVENTION

In accordance with aspects of the present invention, a method for enabling hexagon grid maps to have variable scale with varying levels of map detail at different map scales is provided. The Multi-Level Hex Mapping Method divides hexes of any given size into a number of smaller hexes and defines how the smaller micro-hexes relate to the larger parent hexes. Each different hex size defines a hex level or different scale in the map, thus providing variable scaling to hexagon-based maps. Various mapping attributes may be assigned to selected hexes and micro-hexes, such as terrain data and types. In addition, the method provides a layering mechanism to enable one or more layered attributes, such as tunnels, roadways, buildings, etc. to be associated with selected hexes. The method may be implemented either by the use of computer software or traditional hardcopy maps.

In another aspect of the present invention, details for implementing aspects of the mapping method via computer software are provided. These include map design and rendering operations.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a traditional hex mapping layout;

FIG. 2 is a schematic diagram illustrating the location of hex base points;

FIG. 3 is a schematic diagram illustrating a method of associating parent hexes and micro-hexes using a 5:1 micro-hex ratio, according to one embodiment of the invention;

FIG. 4 is a schematic diagram illustrating three levels of hexes with different micro-hex rations, wherein the higher two levels have a micro-hex ratio of 4:1, and the lower two levels have a micro-hex ratio of 5:1;

FIG. 5 is a schematic diagram illustrating a method of associating parent hexes and micro-hexes having different orientations using a 5:1 micro-hex ratio, according to one embodiment of the invention;

FIG. 6 is a schematic diagram illustrating an alternate method of associating parent hexes and micro-hexes using a 5:1 micro-hex ratio, according to one embodiment of the invention;

FIG. 7 is a schematic diagram illustrating a method of associating parent hexes and micro-hexes using a 4:1 micro-hex ratio, according to one embodiment of the invention;

FIG. 8 is a schematic diagram illustrating another alternate method of associating parent hexes and micro-hexes using a 5:1 micro-hex ratio, according to one embodiment of the invention;

FIG. 9 is a schematic diagram illustrating an alternate method of associating parent hexes and micro-hexes using a 4:1 micro-hex ratio, according to one embodiment of the invention;

FIGS. 10A, 10B, and 10C are schematic diagrams illustrating examples of recommended spatial relationships under the relationship:
micro-hex ratio R/3=X+remainder Y, where Y=0
wherein FIG. 10A shows a 3:1 micro-hex ratio, FIG. 10B shows a 6:1 micro-hex ratio, and FIG. 10C shows a 9:1 micro-hex ratio;

FIGS. 11A, 11B, and 11C are schematic diagrams illustrating examples of recommended spatial relationships under the relationship:
micro-hex ratio R/3=X+remainder Y, where Y=1
wherein FIG. 11A shows a 4:1 micro-hex ratio, FIG. 11B shows a 7:1 micro-hex ratio, and FIG. 11C shows a 10:1 micro-hex ratio;

FIGS. 12A, 12B, and 12C are schematic diagrams illustrating examples of recommended spatial relationships under the relationship:
micro-hex ratio R/3=X+remainder Y, where Y=2
wherein FIG. 12A shows a 2:1 micro-hex ratio, FIG. 12B shows a 5:1 micro-hex ratio, and FIG. 12C shows a 8:1 micro-hex ratio;

FIG. 13 is a schematic diagram illustrating and example of a hex map with a grid overlay having equal hex and grid scales;

FIG. 14 is a schematic diagram illustrating an example of a hex map with a grid overlay with a hex-grid overlay ratio of 2:1;

FIG. 15 is a schematic diagram illustrating details of a hex having a standard aspect ratio;

FIG. 16 is a schematic diagram of a hex with a grid overlay using a standard grid aspect ratio;

FIG. 17 is a schematic diagram illustrating details of a hex having a grid overlay-based hex aspect ratio;

FIG. 18 is a block schematic diagram illustrating an exemplary data structure for implementing aspects of the mapping methods disclosed herein via a computer system, according to one embodiment of the invention;

FIGS. 19a-e illustrate various user interface displays in accordance with an exemplary map design process;

FIG. 20 shows a flowchart illustrating operations and logic performed during a rendering operations, according to one embodiment of the invention; and

FIG. 21 is a schematic diagram of an exemplary computer system that may run software designed in accordance with the principles taught herein.

### DETAILED DESCRIPTION OF PREFERRED EMBODIMENTS

Embodiments of methods for implementing multi-level hex mapping are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise. The specific definitions include:

Angled Hex Scale—the Hex Scale (distance 27) along the line EF as shown in FIG. 15. This is the Angled Hex Scale for the hex with centre point E.

Associated Hex (or Associated Micro-Hex)—a hex that is owned by or associated with another hex.

Base Hex—the hex within a layer of hexes that is at the normal surface level on a map (e.g. ground level). All hex locations that only consist of a single hex and no Layered Hexes are Base Hexes. A Base Hex is also a Primary Hex.

Curved Surface Hex Mapping—a process used to map a curved surface such as the surface of the earth using a hex map.

Declining Priority Level—the priority level assigned to a Hex Data item for defining the priority of that data when compared with data from a Lower Level Hex.

Default Terrain—Terrain Type that is derived from an Associated Hex in a default manner.

Default Terrain Specification—assignment of Terrain Type to a hex through its association with a Micro-Hex or a Parent Hex.

Derived Terrain—Terrain Specification that is derived (usually by computer software) from an Associated Hex, rather than being specified directly by the Map Creator.

Detailed Terrain View—a view of a hex displaying the Terrain Types within the hex as defined by its Associated Micro-Hexes.

Direct Terrain Specification—assignment of a Terrain Type directly to a hex by the Map Creator.

Fixed Terrain—Terrain Type for a hex that is fixed as a certain specified Terrain Type rather than being Default Terrain as determined by a Terrain Derivation Algorithm. Fixed Terrain may be specified by the Map Creator or derived by a Terrain Derivation Algorithm and then nominated as fixed.

Free Map Scaling—Variable Map Scaling without limiting Micro-Hex Ratios to a factor of “1”.

Grid Overlay—a two or three dimensional grid reference system in which the two or three axes of the grid are at right angles to one another, and which is overlaid onto a hex map to provide an alternate method of defining locations on a hex map.

Grid Overlay Aspect Ratio (or Grid Aspect Ratio)—(see FIG. 16) the ratio of the distance between the vertical grid lines 24 of a Grid Overlay, and the horizontal grid lines 26 of the Grid Overlay, as measured on the map, not as measured by the Grid Scale on the surface being mapped.

Grid Overlay Based Hex Aspect Ratio (or Grid Based Hex Aspect Ratio)—a Hex Aspect Ratio that allows a hex map to map to a Grid Overlay using the Standard Grid Aspect Ratio.

Grid Projection System—a system or method used in conjunction with a Grid Overlay to compensate for the curvature of the earth's surface or another curved surface being mapped.

Grid Scale—(refer to FIG. 14) the distance between successive intersection points 30 along each axis of a Grid Overlay expressed as the actual distance across the surface being mapped (for example, a Grid Scale for a topographical map may be 100 metres).

Hex Aspect Ratio—(refer to FIG. 15) the ratio between the width of a hex (distance 21 between points GH) and the height of a hex (distance 23 between points AB) as viewed on a hex map.

Hex Base Point—(refer to FIG. 2) the upper left hex point 40 on a hex boundary when a hex has a flat side uppermost 42, or the uppermost hex point 44 when a hex point is uppermost 44.

Hex Based Grid Overlay Aspect Ratio (or Hex Based Grid Aspect Ratio)—a Grid Overlay Aspect Ratio that allows a Grid Overlay to map to a hex map using the Standard Hex Aspect Ratio.

Hex Data—data relating to a specific hex or group of hexes, generally providing information regarding conditions in the hex but not in any way limited to this type of information.

Hex Data View—a view or display of some or all of the Hex Data relating to a hex.

Hex Edge—(refer to FIG. 2) any one of the six lines 42 that form a hex or hexagon.

Hex Elevation—the actual distance a hex is above or below the Terrain Elevation Datum in the area or surface being modeled or mapped. A Hex Elevation may be positive or negative.

Hex-Grid Overlay Ratio (or Hex-Grid Ratio)—the ratio between the Hex Scale and the Grid Scale at the same level in the same location on a Multi-Level Hex Map with a Grid Overlay.

Hex Layers—a number of hexes at the same location and Hex Level on a map but at different Hex Elevations.

Hex Level (or Level of Hex or Map Level)—a level within the map or subset thereof where all Base Hexes are of the same Hex Scale. Levels within a map are ranked from high to low, with the highest level containing the hexes with the largest Hex Scale, and the lowest level those hexes that have the smallest Hex Scale.

Hex Ownership Algorithm (or Hex Association Algorithm)—an algorithm for determining the ownership or association of hexes.

Hex Point (refer to FIG. 2) the intersection of two adjoining lines that form part of the edge of a hex or hexagon, as depicted by a hex point 40.

Hex Radial (refer to FIG. 15) a straight line joining the centre point of a hex and any one of its Hex Points such as the hex radial 25, which comprising a line between line a centre point E and a hex point G in FIG. 15.

Hex Radius—(refer to FIG. 15) the distance from the centre point of a hex to any one of the Hex Points of the hex. The Hex Radius is equal to the length of a Hex Radial, e.g., the length of line EG.

Hex Scale—(refer to FIG. 15) the distance across a hex measured from the middle of one hex edge to the middle of the opposite hex edge expressed as the actual distance across the surface or area being mapped as represented by a single hex (depicted as the distance 23 in FIG. 15). For example, the hex scale of a topographical map may be set as 100 metres per hex.

Higher Level Hexes—levels within a map where the Hex Scales are larger than the level referred to; i.e., where the hexes represent larger areas.

Historic Terrain—terrain that is historically accurate.

Horizontal Hex Scale—the Hex Scale (horizontal distance) between vertical lines passing through the centre points of adjacent hex columns, such as depicted by distance 29 along the line CD shown in FIG. 15.

Hypothetical Terrain—terrain that is not historically accurate.

Immediate Micro-Hex—a Micro-Hex associated with or owned by a Parent Hex that is one level below the Parent Hex.

Immediate Parent Hex—a Parent Hex associated with or owned by a Micro-Hex that is one level above the Micro-Hex.

Latitude Hex Scaling—a method of Variable Hex Scaling to enable hex maps or Multi-Level Hex Maps to map the curved surface of the earth using latitude to determine the Horizontal Hex Scale.

Layered Hex—a hex in a Layer Of Hexes at the same location but at a different Hex Elevation from the Base Hex within the layer. All Layered Hexes are associated with a Base Hex. The first Layered Hex at any elevation from a Base Hex is a Primary Hex, and may have Subsequent Hexes associated with it at the same elevation from the Base Hex.

Layer of Hexes—hexes at the same Hex Level within a map and the same location but at different Hex Elevations. The hex at the normal surface level of the surface being mapped (e.g., ground level) is called the Base Hex.

Lower Level Hexes—levels within a map where the Hex Scales are smaller than the level referred to; i.e., where the hexes represent smaller areas.

Map Access Key (or Access Key)—the data and type of data by which maps or map locations are selected or accessed.

Map Creator—the person or computer software or any device that creates a map using the Multi-Level Hex Mapping Method.

Map Level (or Hex Level)—a level within the map or subset thereof where all Base Hexes are of the same Hex Scale. Levels within a map are ranked from high to low, with the highest level containing the Base Hexes with the largest Hex Scale, and the lowest level the Base Hexes that have the smallest Hex Scale.

Map Merging—the process of joining two or more Multi-Level Hex Maps into one larger map.

Map Scaling—the process of adding Hex Levels to a map at different Hex Scales.

Map Segmenting—the process of dividing a Multi-Level Hex Map into two or more smaller maps.

Micro-Hex—a hex that is a subset of a Parent Hex; can also refer to any hex that is not at the highest level in a map.

Micro-Hex Association—A logical linkage between a Micro-Hex and its Parent Hex; i.e., the Micro-Hex belongs to its Immediate Parent Hex through the Micro-Hex Association.

Micro-Hex Method—an alternate name for the Multi-Level Hex Mapping Method.

Micro-Hex Ownership—a Micro-Hex is owned by a Parent Hex if the Micro-Hex is associated with the Parent Hex.

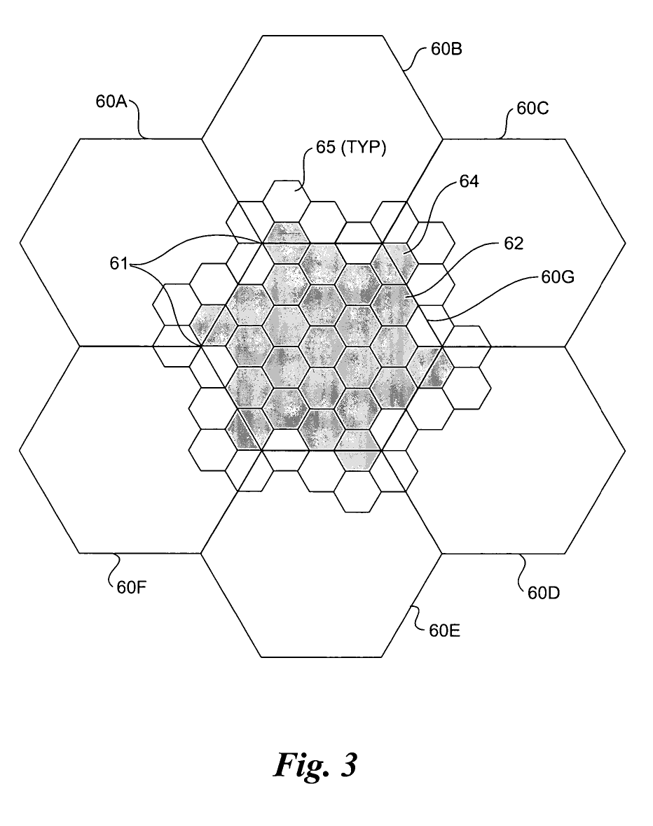

Micro-Hex Ratio—(refer to FIG. 3) the ratio of the size of a Parent Hex 60 to the size of one of its Immediate Micro-Hexes 62 with the size measured linearly across the hexes from the centre of one Hex Edge to the centre of the opposite Hex Edge. It is not measured in terms of the area covered by the hex. As an example a 250 metre Parent Hex containing 50 metre Micro-Hexes would have a Micro-Hex Ratio of 5:1; in this example there are 25 Micro-Hexes associated with each Parent Hex. FIG. 3 provides an example of a Micro-Hex ratio of 5:1.

Multi-Level Hex Map—a map utilising one or more aspects of the Multi-Level Hex Mapping Method.

Object—any object specified by the Map Creator that may be on the map. It may be a group of men, vehicles or pieces of equipment that may or may not form part of an organisational structure in a computer simulation, wargame or other type of game or application using the method.

Object Elevation—the elevation of an Object in its current location as measured at the base of the Object above or below the Base Hex in the same location as the Object. All ground-based Objects normally have an elevation of zero, but may also have an elevation equal to the elevation of any Layered Hexes in the same location. Aircraft may be at any elevation above the Base Hex (or above a Layered Hex with positive elevation if such hexes exist at the location), or zero elevation if on the ground. Boats and ships are normally at zero elevation on hexes containing water (defining the base of such objects as their normal waterline), except for submarines and other underwater vessels, which may be either on or below the surface of the water. Note that watercraft may be limited from moving into water that is too shallow if both their keel depth and the water depth are modeled.

Object View—the information displayed in relation to an Object in a map view.

Overlapping Micro-Hex—(refer to FIG. 3) a Micro-Hex 64 that overlaps two or more Higher Level Hexes; i.e., it is not contained entirely within one hex at the immediate next higher Hex Level.

Parent Hex—a hex that owns or is associated with a number of smaller Micro-Hexes.

Primary Hex—the first Layered Hex at each elevation from a Base Hex in a Layer of Hexes. All Base Hexes are Primary Hexes. Any Primary Hex may have associated Subsequent Hexes at the same location and elevation as the Primary Hex.

Rising Priority Level—the priority level assigned to a Hex Data item for defining the priority of that data when compared with data from a Higher Level Hex.

Secondary Hex—the first Subsequent Hex associated with a Primary Hex.

Skeleton (or Map Skeleton)—a hex map or multi-level hex map that has no terrain information; hence a partial skeleton is a hex map with only a portion of its hexes containing terrain data.

Spheroid Hex Mapping Algorithm—an algorithm for mapping spheroids using hex maps.

Spheroid Mapping Algorithm—an algorithm for mapping the surface of a sphere (such as the earth) into a series of flat maps. This should not be confused with the use of Layered Hexes to model a curved surface.

Standard Grid Aspect Ratio—(refer to FIG. 16) a Grid Overlay 28 with grids that form squares on the map is said to use the Standard Grid Aspect Ratio.

Standard Hex Aspect Ratio—a hex is said to have the Standard Hex Aspect Ratio when it is drawn such that all edges and radials of the hex are the same length.

Subsequent Hex—a hex of the same size and at the same elevation as a Primary Hex. Where multiple Subsequent Hexes exist with a common Primary Hex, the Subsequent Hexes are labeled Secondary Hex, Tertiary Hex, and so on.

Summary Terrain Features—terrain features that are included in Summary Terrain Views.

Summary Terrain View—a view of a hex that shows the dominant Terrain Type within the hex and not the detail of the terrain within the hex as defined in the Micro-Hexes associated with the hex.

Surface Terrain Type—the type of terrain found on the surface level represented by the hex. In a topographic mapping application this would be the type of terrain found on the ground surface, but exclude man-made structures such as buildings, roadways, bridges, etc.

Terrain Derivation—the process of deriving the Terrain Type within a hex from an Associated Hex.

Terrain Derivation Algorithm—an algorithm used to determine Derived Terrain from Associated Hexes

Terrain Elevation Datum—the datum level from which Base Hex elevations are measured.

Terrain Specification—assignment of a Terrain Type or types to a specific hex.

Terrain Type—the topographical or other surface characteristics found in a hex location. These may map a real world location or a hypothetical location, or may be any other surface characteristics in accordance with the surface being modeled, or as determined by the Map Creator.

Terrain View—the view of the Terrain Type or terrain data displayed in a map view.

Tertiary Hex—the second Subsequent Hex associated with a Primary Hex.

Variable Hex Scaling—the use of different Vertical, Horizontal and Angled Hex Scales within a hex map.

Variable Map Scaling—map scaling using different Micro-Hex Ratios between Hex Levels.

Vertical Hex Scale—the Hex Scale (distance 23) along the line AB as shown in FIG. 15.

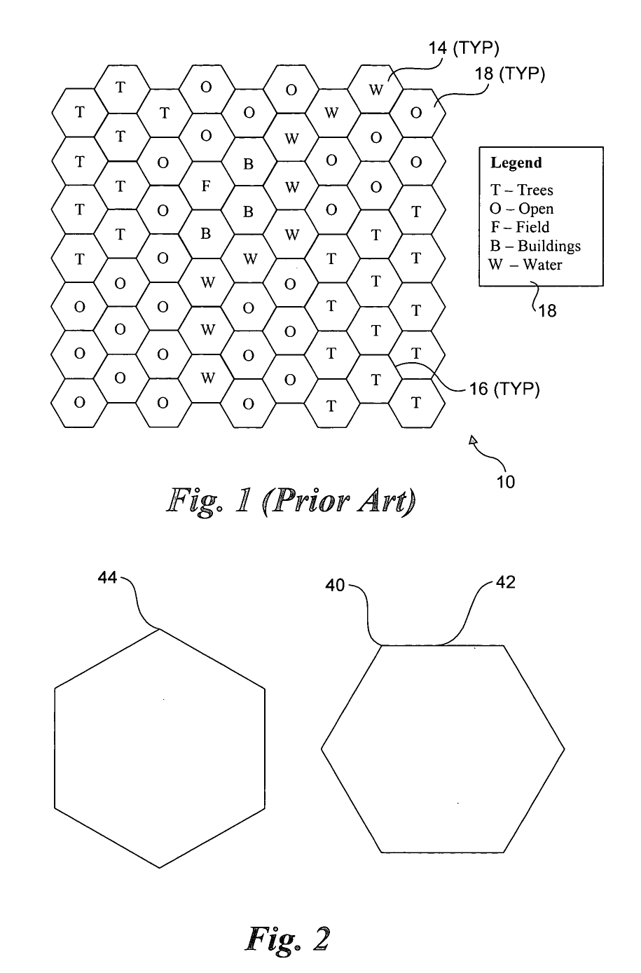

In accordance with aspects of the invention, a multi-level hex mapping method is disclosed herein that provides flexibility and object associations that are not available using traditional approaches. Under the Multi-Level Hex Mapping Method (also referred to as the Micro-Hex Method), a hex-based map is defined to comprise multiple Parent Hexes, having a configuration similar to the conventional hexes 12 of FIG. 1, and a number of smaller hexes called Micro-Hexes, or comprising Base Hexes with Layered Hexes at different elevations or Subsequent Hexes at the same elevation. Each Micro-Hex may comprise, in turn, a number of smaller Micro-Hexes with or without Layered Hexes and Subsequent Hexes such that the map may consist of two or more levels of hexes, with the number of hex levels being determined by the creator of the map. The method may be implemented either by the use of computer software or traditional hardcopy maps, but the main benefits of the method come from using computer software to implement the method.

Under the Multi-Level Hex Mapping Method, each hex (or micro-hex) can be defined as having multiple layers, where each layer represents an area at a specified elevation above or below a base hex elevation. If used in a topographic map, the base hex is normally the hex at ground level, unless the hex terrain is water, in which case the base hex is normally the hex at the water surface level. However, if tides or other time varying water depths are being modeled, the map creator may find it more convenient to have the base hex represent the ground surface level under the water.

The elevation of layered hexes is measured from the base hex elevation, not normally from the terrain elevation datum, but the map creator may choose to measure layered hex elevations from the terrain elevation datum if this better suits the map creator's application. In general, layered hexes may be used to map the floor or bed of an ocean, river or lake (thus mapping the water depth), or to map tunnels or caves below ground level, or floor levels in buildings, or towers above ground level.

A subsequent hex is a hex of the same size and at the same elevation as a primary hex, whether the primary hex is a base hex or a layered hex. Likewise there may be tertiary or further subsequent hexes at any location or hex layer. These are all at the same elevation as the primary hex, and can be used to represent different views of the same location and elevation. Subsequent hexes should not be confused with layered hexes, which are at the same location but different elevations. Layered hexes may also have subsequent hexes.

Subsequent hexes provide the option to have multiple hexes of the same hex scale at the exact same location and elevation on a map. Such hexes may be used to map a building, with the primary hex representing something in the location but outside of the building, whilst a subsequent hex at the same elevation represents the inside of the building at ground level, and may have associated micro-hexes to map the rooms inside the building. Layered hexes can be used to map different floor levels within a building, with associated subsequent hexes mapping different views of these floors and micro-hexes mapping the rooms on these different floor levels.

Each micro-hex is associated with or owned by a larger parent hex in the immediate next higher level of hexes. For example, an exemplary parent hex-to-micro-hex association according to one embodiment is shown in FIG. 3. The diagram shows a plurality of hexes 60A-F surrounding a central hex 60G. A plurality of smaller micro-hexes (shaded) are disposed in or are located proximate to the periphery of Hex 60G, which comprises a parent hex to the micro-hexes. Each of the shaded micro-hexes, such as micro-hexes 62 and 64, are associated with or owned by their parent hex 60G. In addition to hex 60G, each of hexes 60A-F may comprise a parent hex that has its own associated micro-hexes, as depicted by unshaded micro-hexes 65; it is noted that only a limited number of these micro-hexes have been shown in this example in the interest of clarity. Furthermore, in any one map it is not necessary that every hex at a given hex level contain micro-hexes. Some hexes at a given hex level may contain micro-hexes whilst others do not.

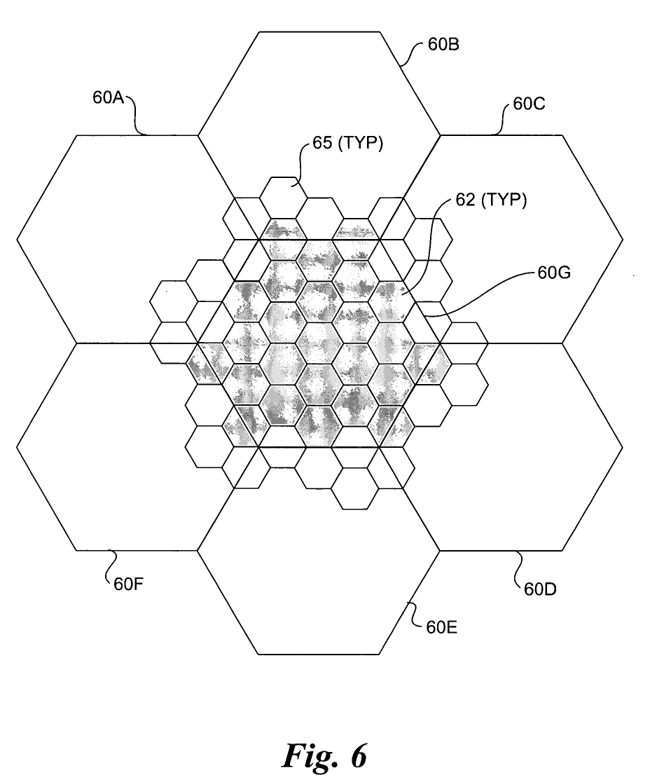

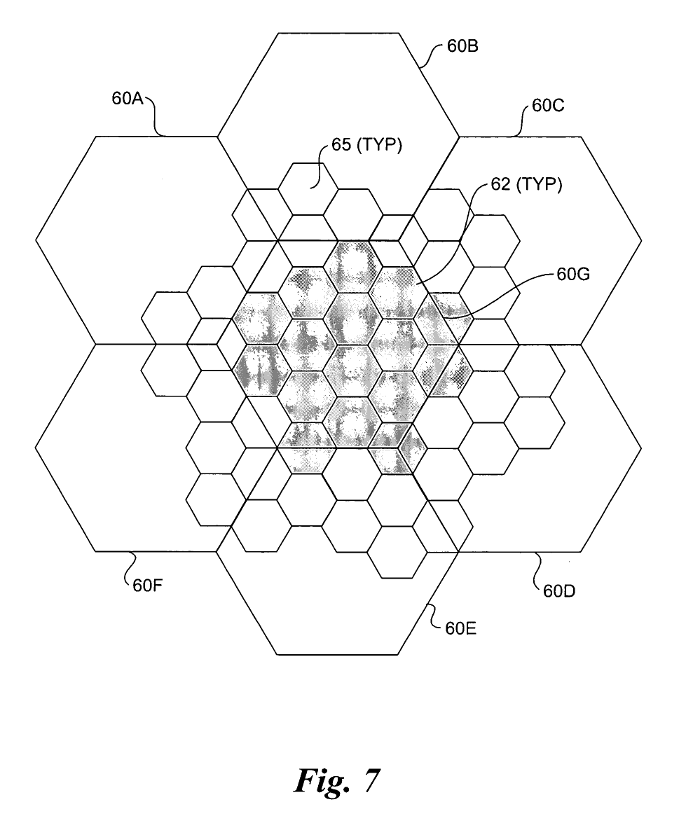

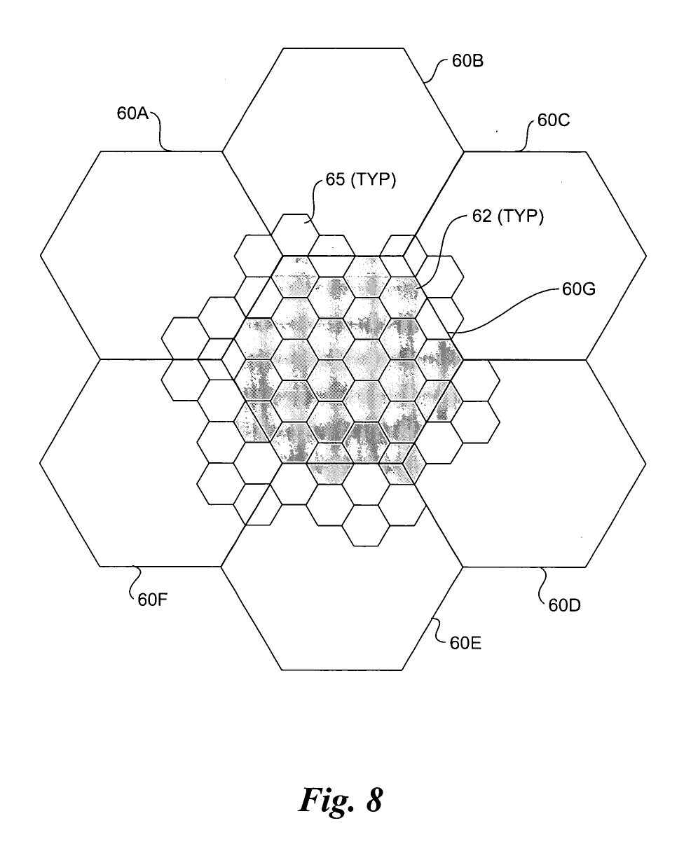

Micro-hexes may be associated with their parent hex in any one of a number of manners. FIGS. 3, 5, 6, 7 and 8 respectively show alternate methods of associating micro-hexes with their parent hex. In each of these diagrams, the shaded micro-hexes 62 are associated with a central parent hex 60G. Again, in each of these diagrams only a limited number of micro-hexes 65 not associated with the central parent hex have been shown for the sake of clarity. Whilst not absolutely necessary, it is far more efficient if the association of micro-hexes with their parent hexes is consistent across each level of parent hexes within a map; in other words, that the relative spatial position and orientation of micro-hexes is the same in relation to each parent hex at the same level in the map.

Every micro-hex on a map must be associated with or owned by only one immediate parent hex. Each parent hex will be associated with a number of immediate micro-hexes with the number determined by the micro-hex ratio. Thus micro-hexes owned by a parent hex should mesh with micro-hexes owned by a parent hex adjoining the first parent hex.

The lowest levels of micro-hexes in a map are not parent hexes, as they have no smaller micro-hexes associated with them.

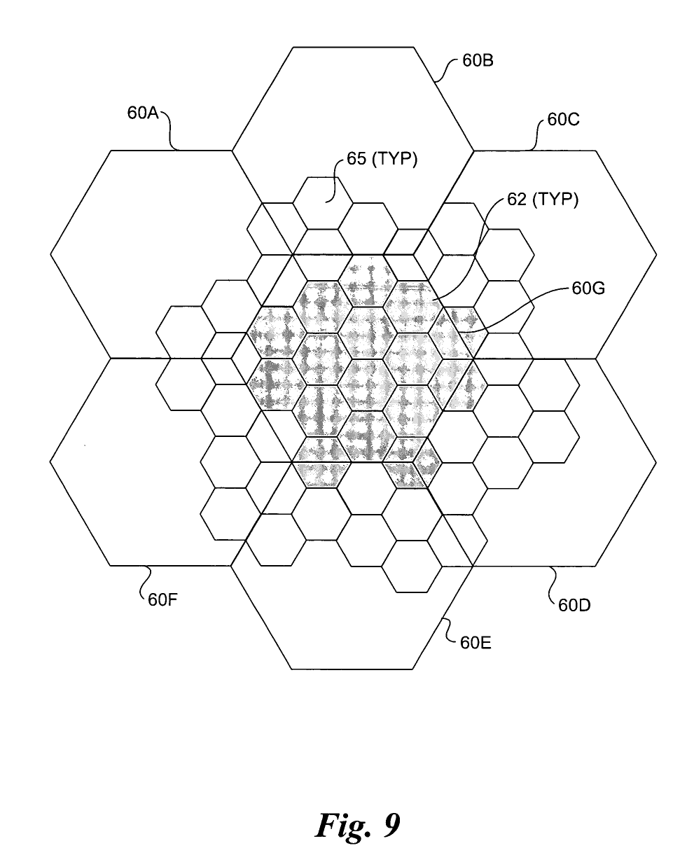

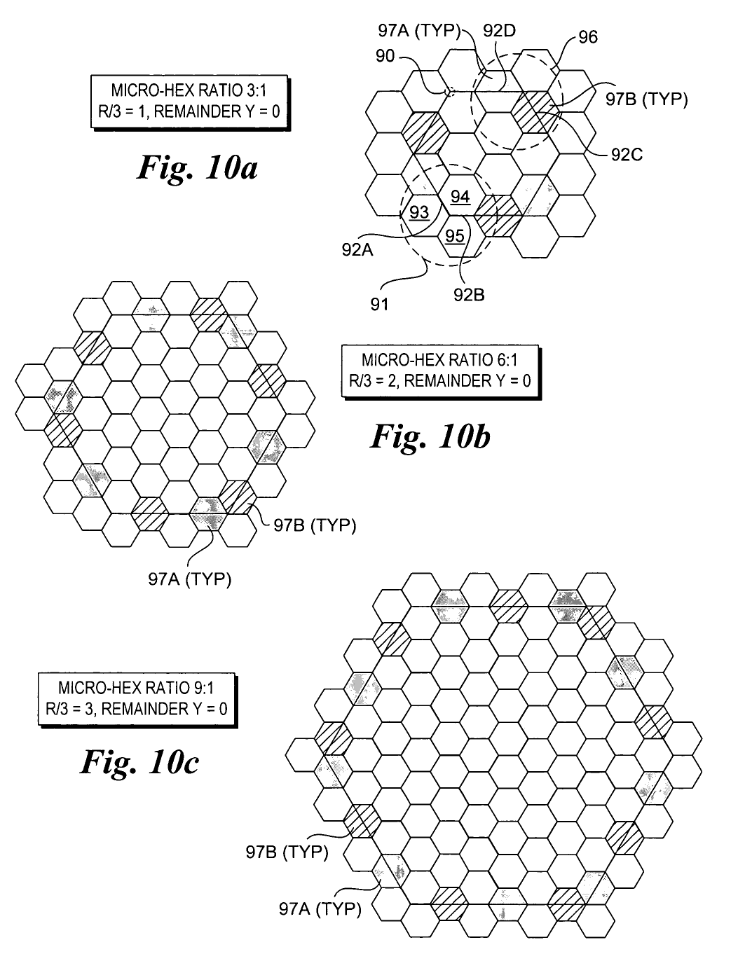

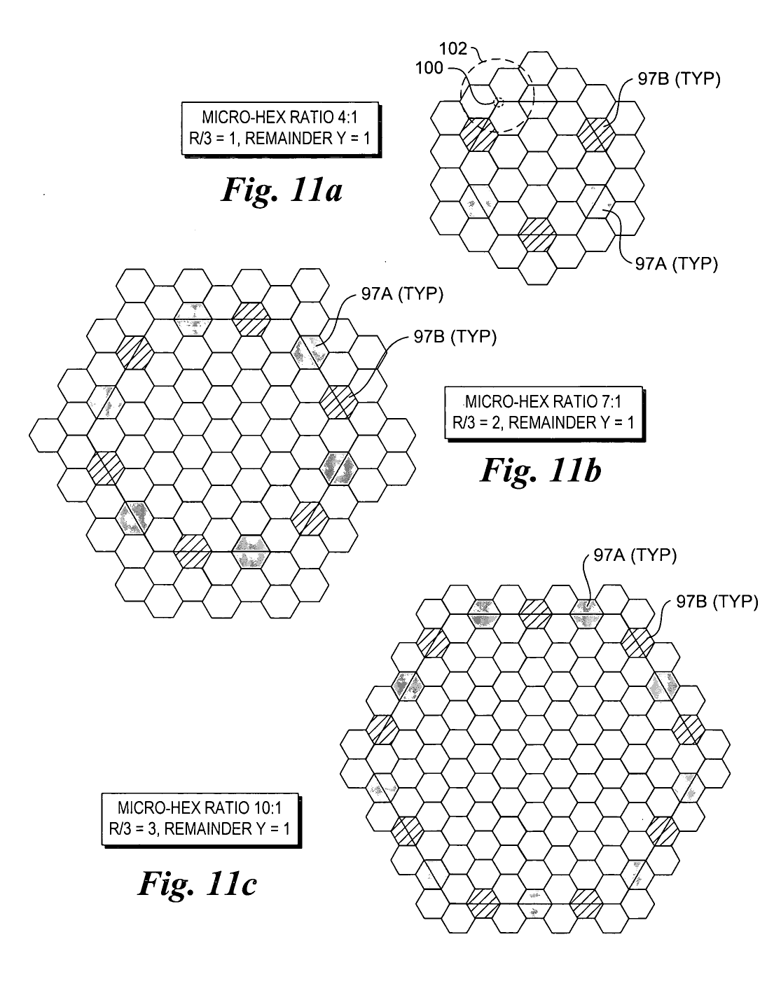

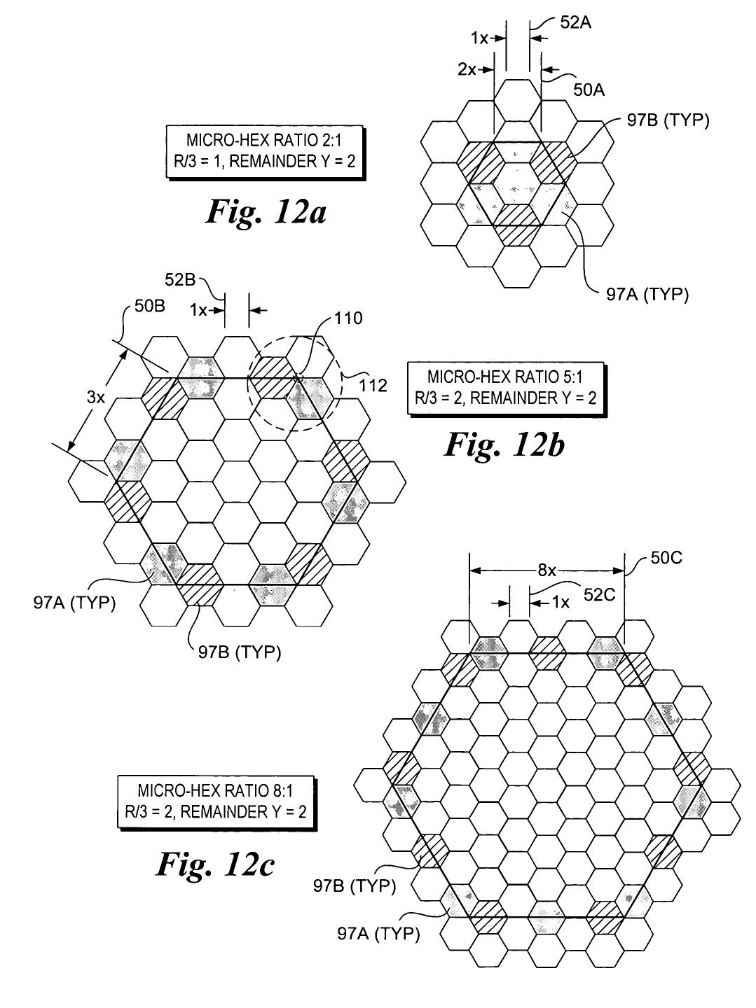

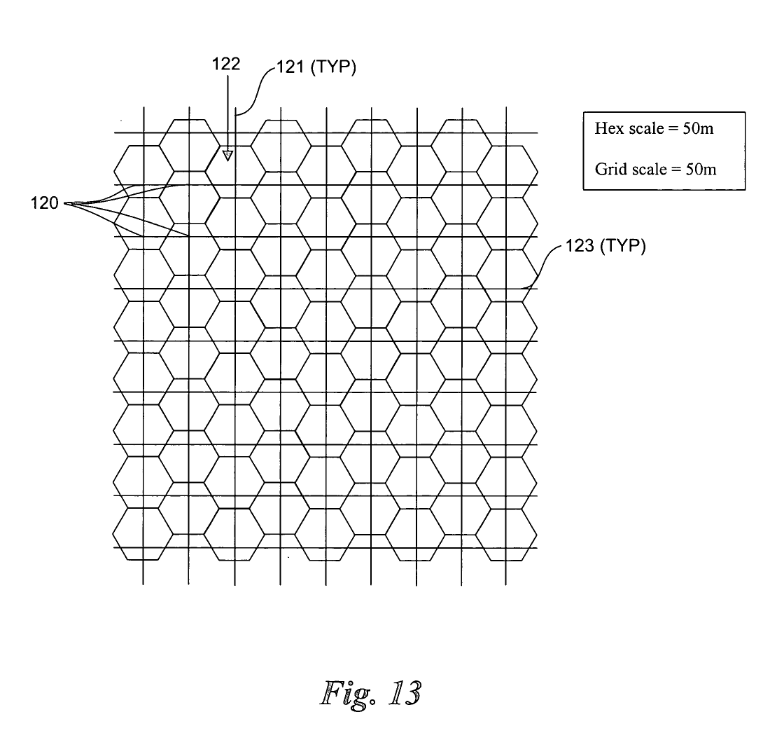

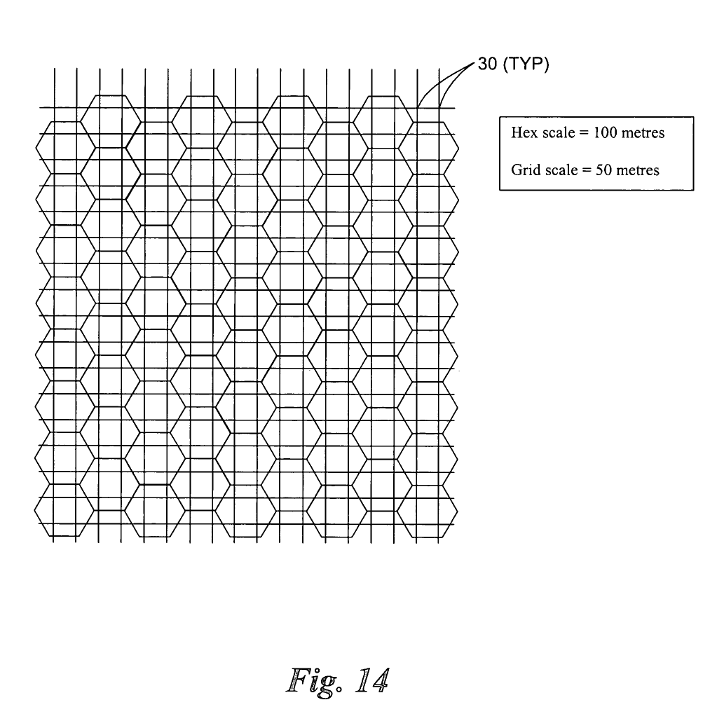

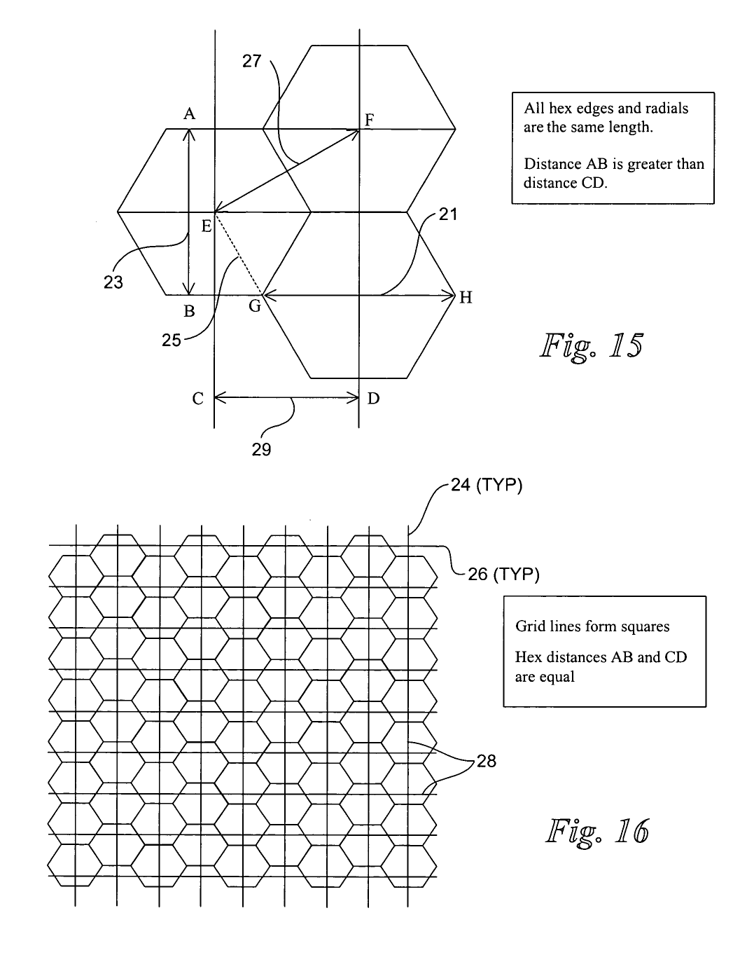

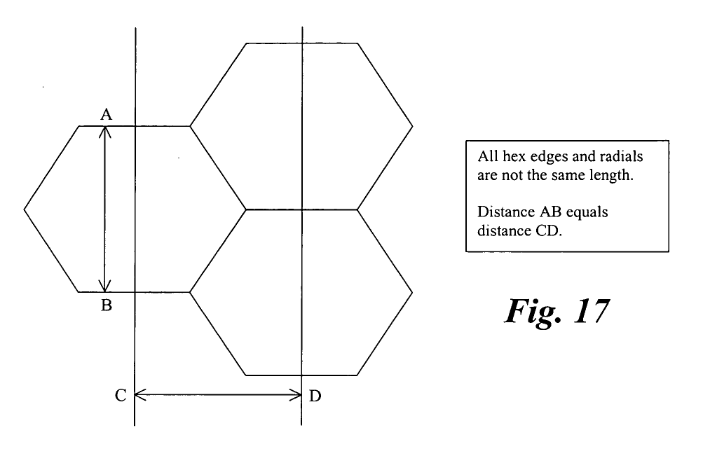

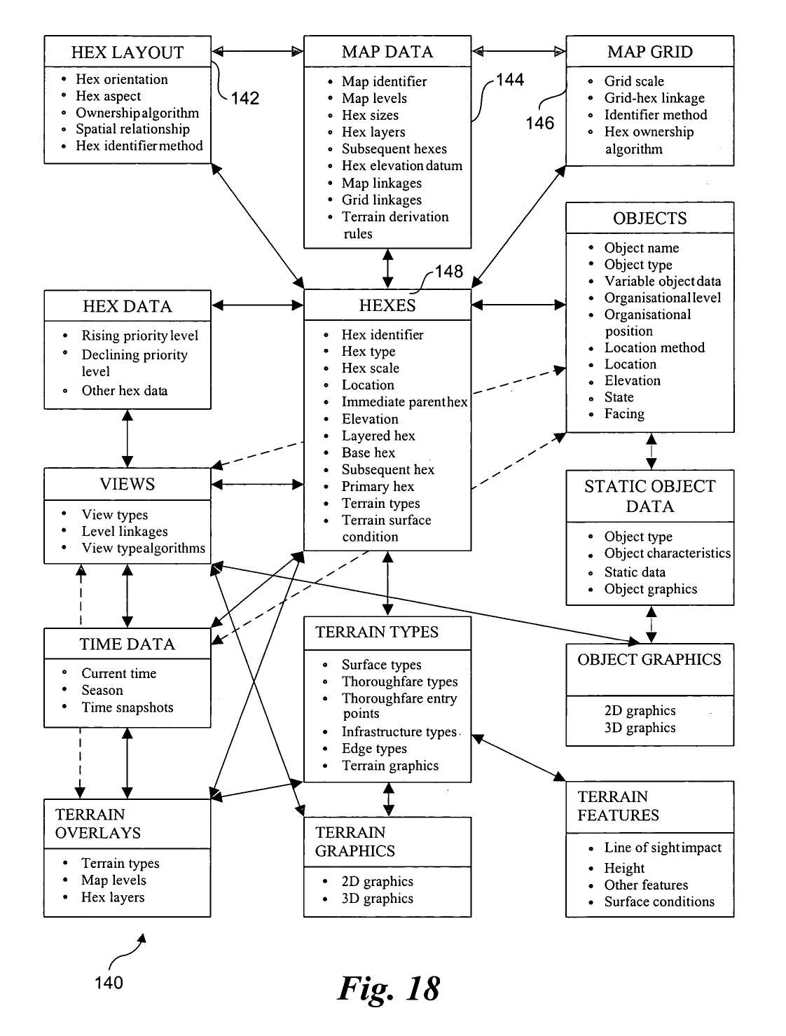

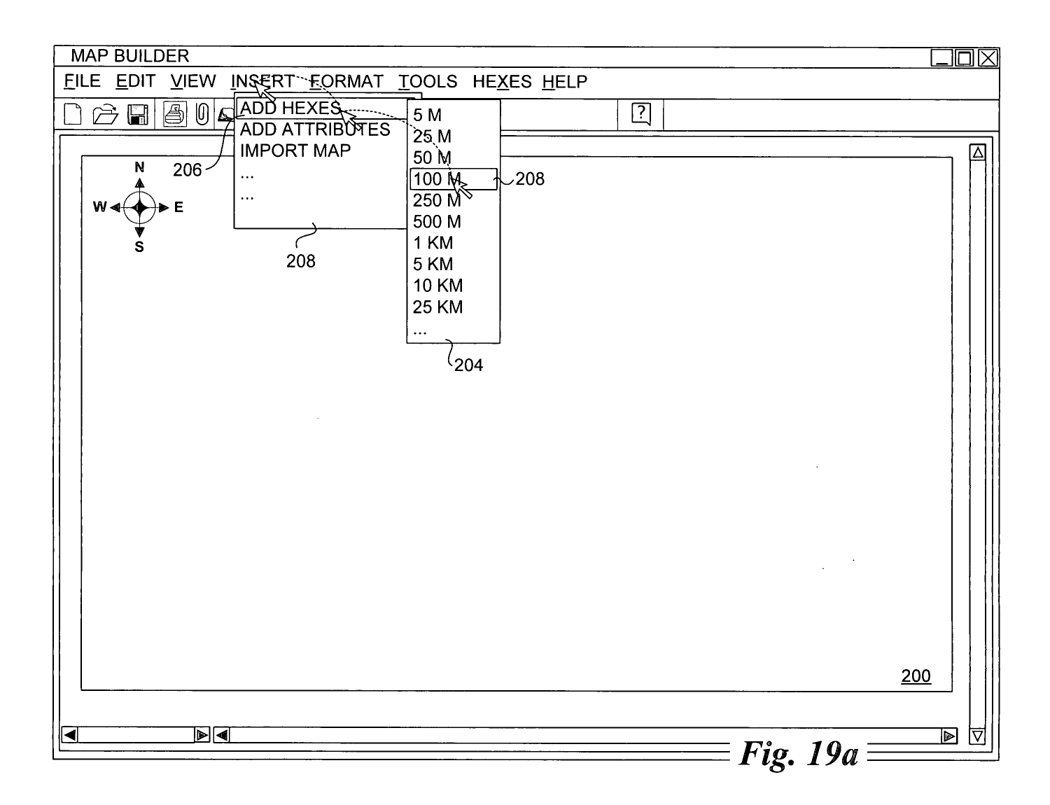

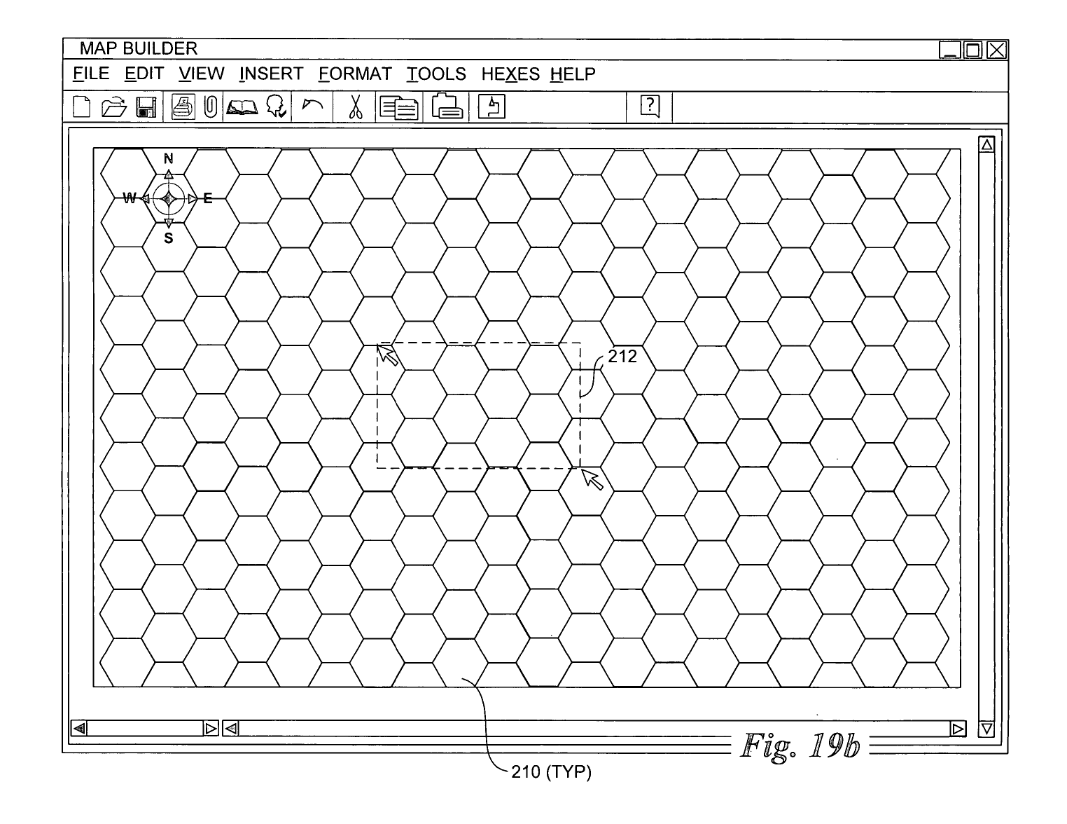

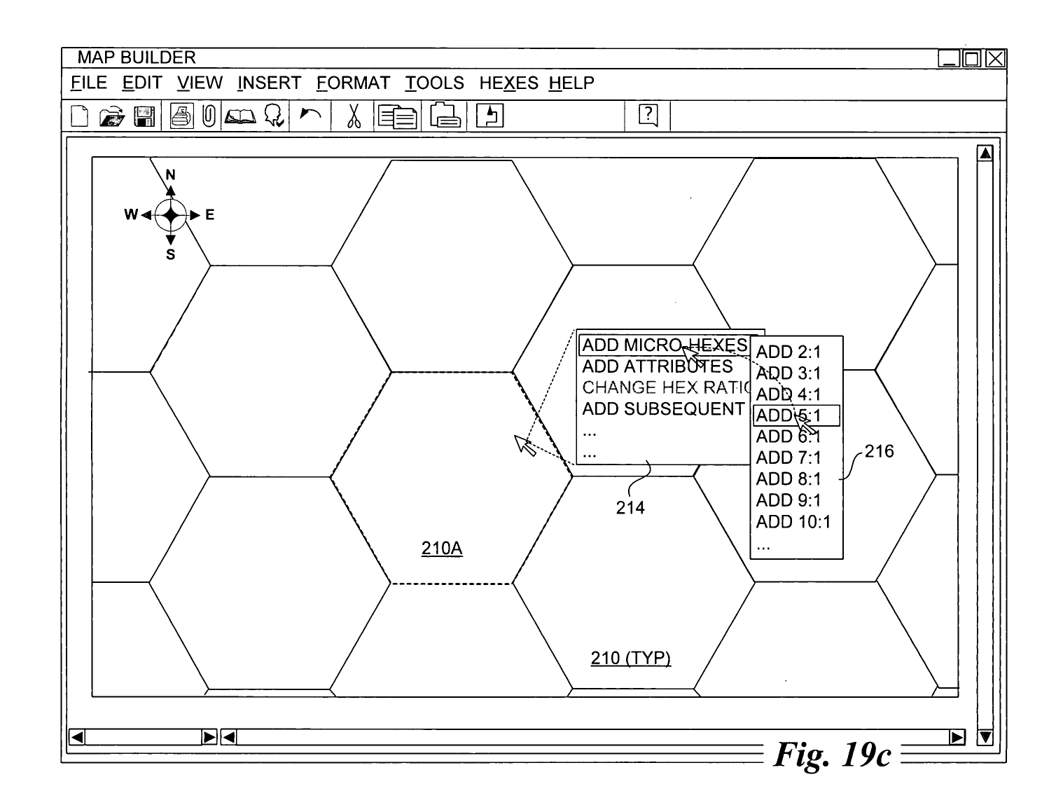

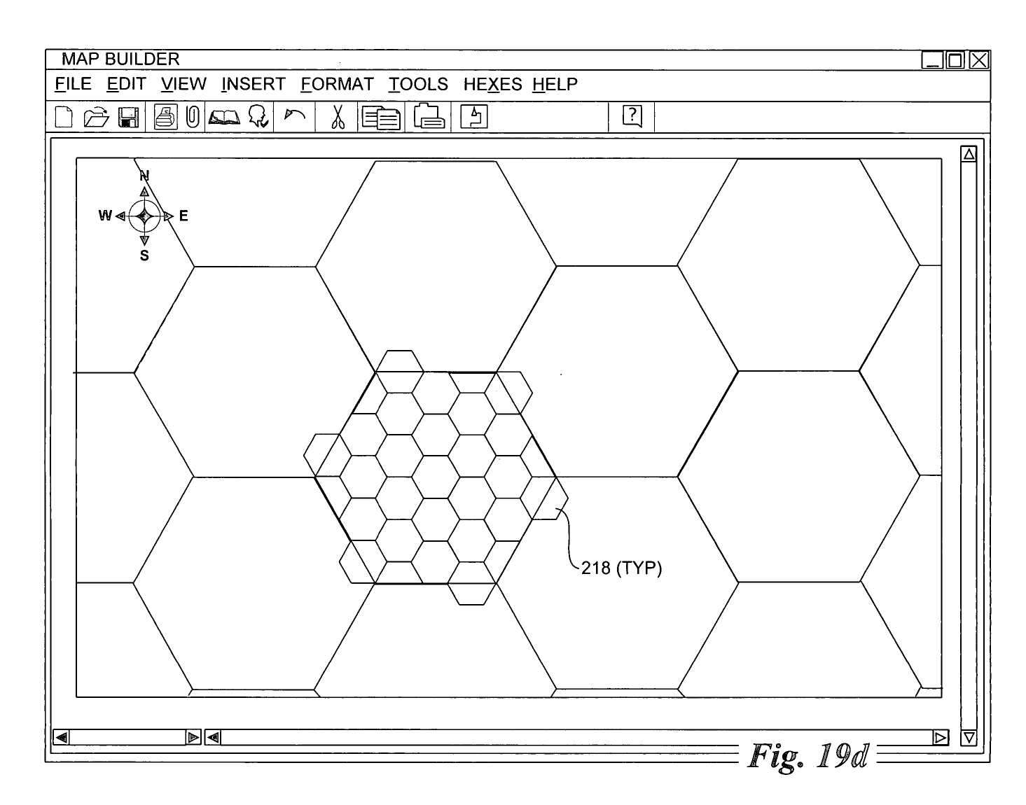

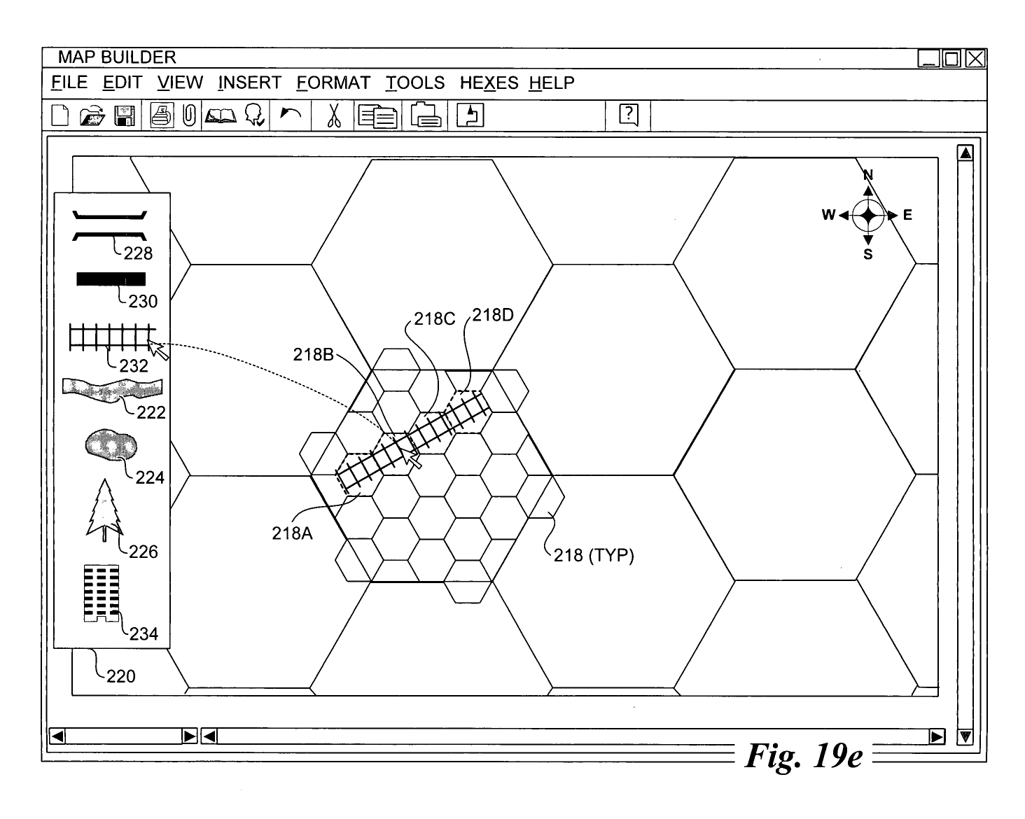

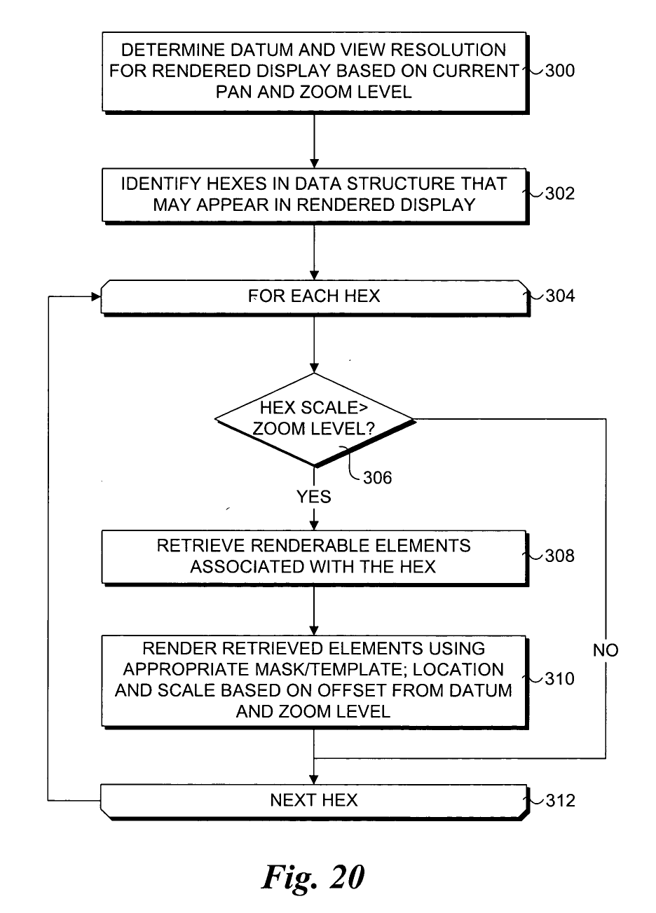

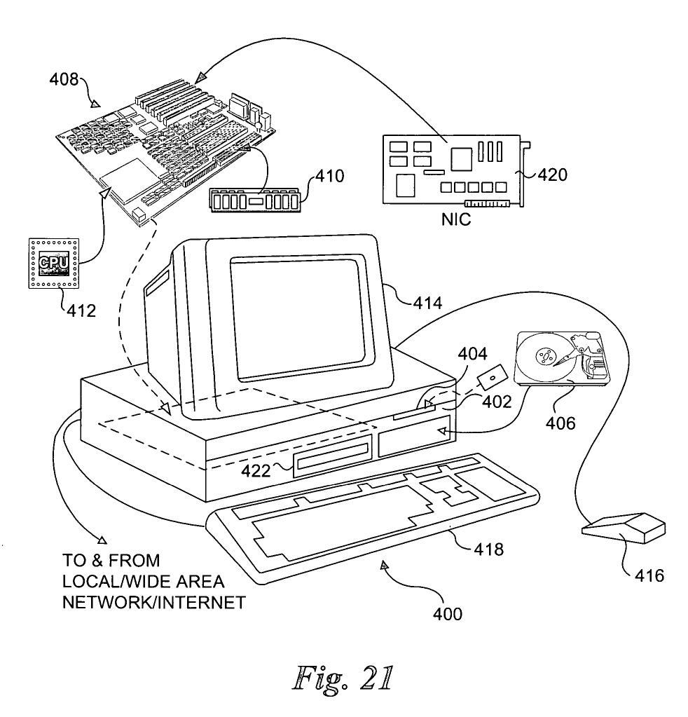

Different micro-hex ratios may require different methods of association of micro-hexes to their parent hexes, but the method of association may be consistent across different micro-hex ratios if the ownership algorithm described below is adopted. Examples of micro-hex ownership with different micro-hex ratios are shown in FIGS. 3 and 9. FIG. 3 shows a micro-hex ratio of 5:1, whilst FIG. 12 shows a micro-hex ratio of 4:1. The relationship of the micro-hexes to their parent hex in these two examples is different by necessity due to FIG. 3 having all parent hex points 61 coincide with micro-hex points whereas this is not the case in FIG. 9.

A micro-hex is associated with one parent hex at each hex level above the micro-hex through progressive associations with firstly its immediate parent hex and then the association between its immediate parent hex and the associated parent hex at the next higher hex level, and so on, until the highest hex level in the map is reached.

Each parent hex is associated with a number of immediate micro-hexes, and through these micro-hexes to associated micro-hexes in the next lower level, and so on, until the lowest level micro-hexes in the map associated with the original parent hex are reached.

The micro-hex ratio is the ratio of the parent hex scale to the micro-hex scale of the immediate micro-hexes associated with the parent hex. For example, FIG. 12a shows a micro-hex ratio of 2:1, wherein the parent hex scale 50a (i.e., length of one side of the parent hex) is twice the length of the micro-hex scale 52a. In FIG. 12b, the ratio of parent hex scale 50b to the micro-hex scale 52b leads to a micro-hex ratio is 3:1. Similarly, in FIG. 12c the ratio of parent hex scale 50c to the micro-hex scale 52c leads to a micro-hex ratio is 8:1. In general, micro-hex ratios should be expressed as R:1 where it is recommended that R be a whole number.

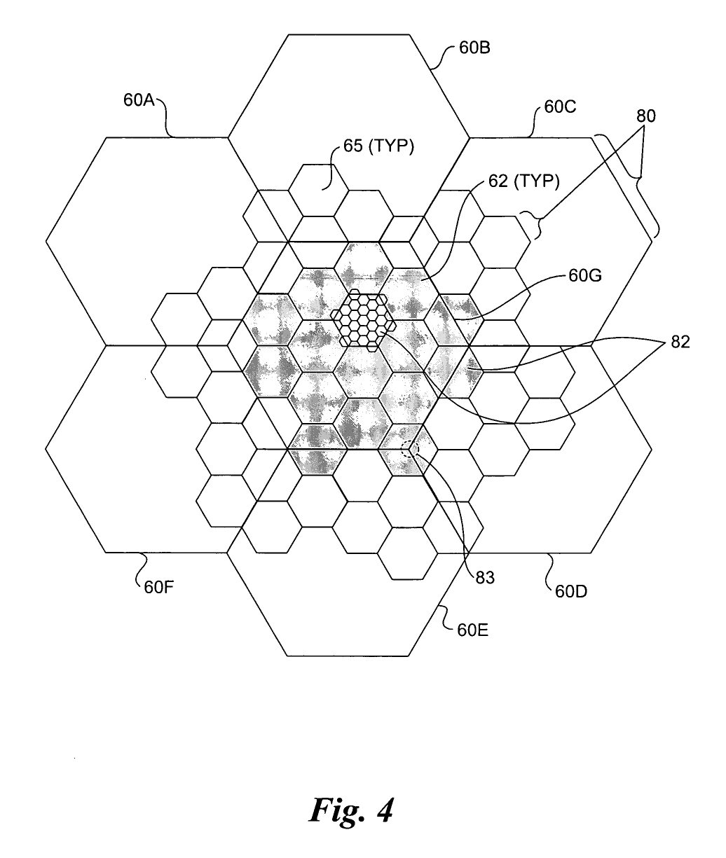

The micro-hex ratios in a map can vary at different hex levels within the map, across different parent hexes within a map, and across different layered hexes in the same location. For example, FIG. 4 shows an example of three levels of hex with two different hex ratios. In this diagram the micro-hex ratio between the two higher levels 80 is 4:1, whilst it is 5:1 between the two lower levels 82.

As an example of the use of different ratios across different layers within a hex location, the smallest base hex in a location with open terrain may have a hex scale of 50 metres, but a layered hex mapping a tunnel in the same location may have a scale of 5 or 10 metres to map the detail of the tunnel location. In this situation the hex ratio for the base hex to its parent is different to the hex ratio for the layered tunnel hexes to the parent of the base hex. The same method can be used to map rooms inside a building.

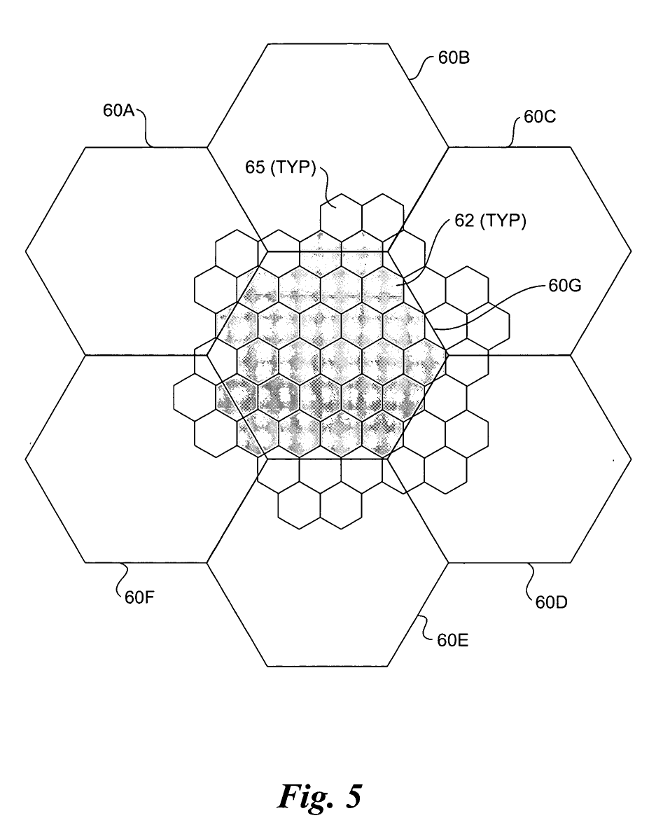

Whilst it is not strictly necessary that micro-hexes be oriented the same way as their parent hexes, it is far more efficient if they are. In each of FIGS. 3, 4, and 10a-c, 11a-c, 12a-c, 9a-c, 10, 11 and 12 the micro-hexes are oriented the same way as their parent hexes, whilst in FIG. 5 the micro-hexes 62 and 65 are oriented differently to their parent hexes 60N. The use of a common orientation between micro-hexes and their parent hexes makes it easier to have a consistent method of association of micro-hexes to their parent hexes within each hex level. This is not readily achieved if the micro-hex orientation is different from the parent hex.

The spatial relationship between a parent hex and its immediate micro-hexes refers to the location of the micro-hexes in relation to the parent hex. For the best use of micro-hexes it is best that the hex points of a parent hex always coincide with hex points of micro-hexes at the next lower level. This is not the case in FIG. 4, as shown for the lower right hex point 83 of the central largest parent hex in this diagram. In FIGS. 3, 6, 10a-c, 11a-c, and 12a-c, the parent hex points always coincide with micro-hex hex points, whilst in FIGS. 4, 5, 7, 8, 9 this is not the case.

It is recommended that the following algorithms be used. For the purpose of simplicity it is assumed here that, referring to FIG. 2, all hexes in a map are oriented with a flat side 42 uppermost, rather than a hex point 44 uppermost. This is the best orientation of hexes and micro-hexes, and is the orientation most commonly used in traditional hex maps. However, the algorithms hold true irrespective of the hex orientation as long as all hexes in a map have the same orientation.

With micro-hex ratios expressed as R:1, the following formula should be applied:
R divided by 3=X plus a remainder of Y
where X is a whole number and the remainder Y=0, 1 or 2.
(a) If remainder Y=0, as shown in FIG. 10a, then the two hex edges joining at the hex base point 90 in the parent hex can overlay either micro-hex edges immediately adjacent to the parent hex base point 90 or micro-hex radials immediately adjacent to the parent hex base point, but at the next hex point moving around the periphery of the parent hex the parent hex edges will overlay micro-hex radials if the parent base point hex edges overlay micro-hex edges, or overlay micro-hex edges if the parent base point hex edges overlay micro-hex radials. (The parent hex edges that overlay micro-hex edges or radials refer to the parent hex edges immediately adjacent to the parent hex points.) Detail 91 shows a micro-hex edge overlay condition, wherein parent hex edges 92A and 92B overlay the edges of adjacent micro-hexes 93, 94, and 95, while detail 96 shows a micro-hex radial overlay condition under which parent hex edges 97A and 97B overlay the radials of micro-hexes 92C and 92D. Similar conditions are shown in each of FIGS. 10b and 10c. Also, when Y=0, the parent edge overlay types alternate as you move from hex point to hex point around the circumference of the parent hex.
(b) If remainder Y=1, as shown in FIGS. 11a-c, then the two hex edges joining at a hex base point 100 (FIG. 11a) in the parent hex should overlay micro-hex edges immediately adjacent to the parent hex base point, as exemplified by detail 102. The parent hex edges will overlay micro-hex edges immediately adjacent to all the parent hex points in this situation.
(c) If remainder Y=2, as shown in FIGS. 12a-c, then the two hex edges joining at a hex base point 110 (FIG. 12b) in the parent hex should overlay micro-hex radials immediately adjacent to the parent hex base point, as exemplified by detail 112. The parent hex edges will overlay micro-hex radials immediately adjacent to all the parent hex points in this situation.

Some micro-hexes will overlap two or more parent hexes; i.e. they will not be contained entirely within just one parent hex. These overlapping hexes are shown in FIGS. 10a-c, 11a-c, and 12a-c as overlapping hexes 97A and 97B. The following algorithm assumes use of the recommended micro-hex spatial relationships algorithm as described above, and of micro-hex ratios that consist only of whole numbers. The use of this spatial relationships algorithm ensures that no micro-hex will overlap more than two hexes at the next higher hex level.

As shown FIGS. 10a-10c, when Y=0 there will be an even number of overlapping micro-hexes 97A and 97B around the periphery of a parent hex irrespective of the micro-hex ratio used (as long as the ratio is R:1 where R is a whole number). For example, the hex configurations of FIG. 10a, 10b and 10c respectively include 6, 12, and 18 overlapping hexes.

The recommended algorithm for determining parent hex ownership for micro-hexes is as follows:
(i) Any micro-hex contained entirely within an immediate parent hex will be owned by that parent hex.
(ii) To determine the ownership of micro-hexes that overlap two parent hexes, start at a parent hex base point (e.g., parent base point 90 of FIG. 10a) and move in a clockwise direction around the perimeter of the parent hex, the odd numbered overlapping micro-hexes are owned by the parent hex in question, and even numbered overlapping micro-hexes are not.

This algorithm delivers consistent micro-hex ownership and parent hex/micro-hex meshing subject to:
(a) common hex orientation;
(b) micro-hex ratios of R:1 where R is always a whole number; and
(c) use of the recommended micro-hex spatial relationships algorithm.

In addition to the foregoing rules, a micro-hex can only be owned by one parent hex at the immediate next higher hex level.

Thus, as shown in each of FIGS. 10a-c, 11a-c, and 12a-c, every second overlapping micro-hex 97A (shown as shaded) encountered when proceeding from the parent hex base point (e.g., 90, 100, and 110) around the periphery of the parent hex is owned by the parent hex, while the other overlapping micro-hexes 97B (shown as cross-hatched) are owned by the parent hex adjacent to the particular edge where the overlapping occurs.

It is desirable but not absolutely essential that every hex in a map is specified as containing a particular terrain type. Each lowest level base hex micro-hex at any given location can contain only one directly specified fixed surface terrain type unless special terrain types are defined that in effect simulate stratified or conditional terrain types. Potential examples of this are (i) terrain with multiple levels such as ground level and one or more underground levels to model tunnels or building basements, or above ground levels to model storeys of buildings; (ii) a building terrain type that allows something to be either inside or outside of the building; and (iii) water where something may be on the surface of the water or at some level under the water. These examples represent an alternate method to the layered hex method for modelling terrain at multiple levels within the same hex location. In addition, terrain may be nothing to do with topographic features, but may be any features relating to the surface being mapped.

All hexes at levels above the lowest level of micro-hexes in a map may contain multiple terrain types, with each of the lower level micro-hexes defining the terrain type within a discrete area within these hexes. In addition to natural topographic features, terrain may also include man made features such as buildings or fortifications, or any other type of infrastructure.

Hexes may also contain roads, railway tracks, trails, rivers and streams, and other types of thoroughfares and linear features. These features are in addition to the surface terrain type covering the area defined by the hex. Multiple thoroughfares may be allowed in a single hex, and thoroughfares should be connected with at least one hex edge at the lowest level hex scale used in the map to define the entry edge used by the thoroughfare.

Terrain types may also be specified for hex edges, with examples being walls, gullies, streams, and other typically linear features. Each of the six edges of any hex may have a different edge terrain type, or no edge terrain type. Edge terrain types are independent of the hex terrain type, which covers the area mapped by the hex. Furthermore, terrain features may be used to depict connections between layered hex levels; for example a staircase between two floors in a multi-level building, or a ladder going down into a sewer or tunnel complex.

The terrain type can be specified directly at the lowest level micro-hexes (unspecified hexes may be defined as “null” terrain by default), and parent hexes can display either the terrain type as determined by the associated micro-hexes (either the immediate micro-hexes or some lower level micro-hexes), or the terrain type specified for the parent hex.

Parent hex terrain types may be specified as summary terrain features, in which case a view of the parent hex may only show summary terrain feature information. An example of this would be summary terrain information showing roads and railway tracks but not other terrain details in the land surrounding such thoroughfares. Alternately a parent hex may be specified as having its own terrain type. Different map views may display summary terrain information for a hex or display the terrain type specified for the hex. Preferably, multiple views of hexes should be available, especially when the method is implemented using computer software, as described in further detail below.

If a hex has no specified terrain type, it will adopt as a default terrain specification the terrain specified by either (i) the next lower level associated micro-hexes with terrain specified (see below regarding terrain derivation algorithms); or (ii) the terrain specified for the next highest level parent hex that has terrain specified. It is thus possible for a hex that does not have a direct terrain specification of its own to have multiple default terrain specifications based on terrain specifications of associated micro-hexes and associated parent hexes. Different default terrain specifications may be used in different circumstances.

Terrain overlays may be used to store and display different terrain information, or any combination of the terrain information stored in each overlay. An example of the use of this overlay method is to use one overlay to store base ground terrain information, such as open ground, a second overlay to store information on roads and other thoroughfares, a third overlay to store hex edge terrain information, and a fourth to store information regarding buildings. These overlays could then be used, for example, to show roads and buildings, but exclude the display of ground and hex edge terrain information.

Terrain surface conditions data can also be stored to provide information regarding the conditions of surface terrain in any given hex. Examples of these conditions could be muddy, dry, dusty, snow covered, etc.

Terrain derivations are methods for deriving terrain information for a hex at a given level from terrain information for hexes at other levels or hexes at different layers within the same level. These derivation methods are used to automatically determine terrain information at different levels and layers based upon information entered onto the map by the map creator in order reduce the effort required to produce maps using the Multi-Level Hex Method. In general, terrain derivations may be used to determine summary terrain information or detailed terrain information.

The following are just some derivation types, methods and algorithms for deriving terrain for terrain views and terrain specification. Derivation algorithms need to be selected that best suit the application for which the map is used.

Parent hex from micro-hex, detailed view—the parent hex will show the terrain as specified in the immediate next lower level micro-hexes. Thus if the micro-hexes owned by the parent hex contain different types of terrain, the parent hex in this view will show multiple terrain types as per the micro-hex locations within the parent hex. This is just a view of terrain within the parent hex, and should not be confused with the specification of terrain in the parent hex.

Parent hex from micro-hex, summary view—in the summary view the parent hex shows a single surface terrain type derived by applying a formula to the micro-hex surface terrain types across the micro-hexes owned by the parent hex, and may also show summary terrain features. The formula for selecting the surface terrain type may be determined by the map creator, or written into the software used to implement the Multi-Level Hex Mapping Method. (This derived surface terrain for a summary view should not be confused with summary terrain features.) An example of such a formula is:
(a) If a ground surface terrain type is contained in more owned micro-hexes than any other surface terrain type, apply this terrain type to the parent hex;
(b) If no single ground surface terrain type is contained in more owned micro-hexes, select the parent surface terrain type based on applying a precedence list of surface terrain types to the surface terrain types that belong to the equal highest number of owned micro-hexes with that type, choose the surface terrain type with the highest precedence, and then apply it to the parent hex;
(c) Select thoroughfares (roads, paths, railway lines) based on a precedence listing of thoroughfares, and select the number and type of thoroughfares to be shown as determined by numbers and types linked to the hex level, or numbers and types specified by the map creator or by the software used to implement the method;
(d) Ignore micro-hex edge terrain, unless the terrain is a waterway of a defined type (e.g., impassable to vehicles);
(e) Calculate parent hex elevation as an average of the various elevations of the base micro-hexes owned by the parent hex.
   Different formulae may be used to provide different views within either detailed views or summary views, or for different applications of the map.

Parent hex from micro-hex, default specification—this specifies the type of terrain in the parent hex based on the terrain contained within the micro-hexes owned by the parent hex. A formula such as the one described above can be used, or the default specification formula may be different from the formula used to determine the terrain views. Different formulae may be used to derive multiple default terrain specifications for different purposes.

Parent hex from micro-hex, fixed specification—a fixed terrain specification is a terrain specification that is defined as being fixed for specific use by an application using the map created under the method. A fixed terrain specification may be defined in a similar manner to a default terrain specification as stated above and may be derived using the same formula or a different formula, or may be determined by the map creator.

Micro-hex from parent hex, normal default specification—the normal default specification for a micro-hex is that the micro-hex will contain:
(a) the same surface terrain as the parent hex;
(b) thoroughfares that will be mapped to micro-hexes within the parent such that the number, type and parent entry hex edges are consistent with these parameters in the overall parent hex. In other words, if there is one sealed road crossing the parent hex, only a suitable number of micro-hexes will contain a sealed road such that in the detailed views of the parent hex, which is based on the immediate micro-hexes, there is still only one sealed road crossing the parent hex, with road entry points on the same edge or edges of the parent hex;
(c) structures that will be derived for the micro-hexes based on structures contained in the parent hex, or some formula for allocation of structures to the micro-hexes;
(d) the same elevation as the parent hex.

Micro-hex from parent hex, random default specification—in random default specification the terrain type is allocated randomly to the micro-hexes within a parent based on the terrain type contained within the parent, and some parameters provided by the map creator or set within the software used to implement the mapping method. The random allocation of terrain to micro-hexes will normally be done in such a manner that the terrain in the micro-hexes across the parent hex is sensible when compared with the environment being mapped, including sensible variations in terrain elevations. This random default specification will vary across parent hexes such that the micro-hex terrain derived by this method will be different across different parent hexes. This method may be combined with the normal default specification such that some features such as thoroughfares and structures are defined normally, but others such as elevation and surface terrain are defined randomly.

Micro-hex from parent hex, pre-set default specification—as an alternative to normal and random specification of micro-hex terrain from the parent hex, the map creator may define a series of preset default specifications, and apply these to various parent hexes in order to define micro-hex terrain.

Micro-hex terrain derivations will generally result in hypothetical terrain, namely terrain that is not historically accurate in all details when compared with the real location or environment being mapped at the time that the map is representing. Formulae can be developed to minimize the differences between hypothetical terrain derivations and historic terrain. Generally, parent hex terrain derivations should be historically accurate to the extent that the owned micro-hex terrain is historically accurate.

The map creator might derive terrain derivations from terrain in an immediately adjacent level or any other level, as chosen. Rules or formulae for terrain derivation can vary at different levels, and may require precedence rules to be established to overcome conflicts arising from multiple derivations. Rules for deriving terrain in different layers need to be defined in accordance with the specific application of the method, and can be specified by the map creator or via the software implementation of the Multi-Level Hex Mapping method.

Hex data and hex terrain information can be displayed using a range of graphics, including two dimensional graphical representations and three dimensional representations. Various graphics can be linked to hexes directly or via terrain types with use of these graphics being determined by the terrain type and hex data, and any other data determined by the map creator, including time and season data.

A wide range of data may be associated with any hex or range of hexes. Such data may specify surface conditions (e.g., muddy, dry, dusty, etc, for land, or calm or choppy or wave heights for water), tide and current directions and speed for water, weather, visibility, cloud levels and density, wind speed and direction, or any other information associated with the surface mapped by the hex at the time the map is representing.

Hex related data might be displayed at different hex levels in various manners and levels of detail, and the level of detail may be linked to the hex level being viewed. Hex data may also be derived in manners similar to terrain derivations.

Hex data may be assigned a rising priority level and/or a declining priority level. A rising priority level defines the priority of the data when compared with the hex data from a higher-level hex, and a declining priority level defines the priority of data when compared with data from a lower-level hex. These priorities can be used to resolve conflicts between hex data (derived or otherwise) at different levels, and can be used in applications incorporating or using the Multi-Level Hex Mapping method.

Objects may be displayed on a map in the Multi-Level Hex Mapping Method. An object may be any item that the map creator wants to locate on the map, and may be movable, fixed in one location, or limited to a specific terrain type or range of terrain types, or restricted to a type of thoroughfare. Objects may have varying states, such as mobile or stationary or any other states that the map creator chooses to assign to the objects.

If an object is part of an organisational structure, the level of the object or group of objects displayed may be varied with the hex level displayed, and the level of the object within the organisational structure may be linked to the hex level being viewed. To use a wargame example, objects may be units within an army. In an army organisational structure, squads are subsets of platoons, which in turn are subsets of companies, which in turn again are subsets of battalions. In such a structure, the organisational structure may be linked to the hex levels in the map on which the organisation is located such that different levels of the organisation are displayed with different hex levels of the map. The linkages are established by the map creator, as are the display options at each hex level. In the example referred to, if a four level hex map is used, the lowest level may display symbols or graphics for all squads in the micro-hexes in which the squads are located, the second lowest hex level may display a graphic for each platoon, but no graphics for individual squads, the third level (counting upwards from the lowest level) may display a graphic for each company, but no graphics for squads or platoons, whilst the fourth and highest level may display graphics only for each battalion located in the map. Display options may allow sub units at different levels in the organisation to be displayed at any hex level in the map.

Time may also vary as a fourth dimension in a Multi-Level Hex Method map. Hex terrain, hex data, and the location and state of objects on the map may vary over time. For example, an object may be a vehicle that can change hex locations over time, and can be in either a mobile or stationary state. Hex data may describe the weather conditions in a hex at a given time, and such data may vary over time.

Map scaling is the process of adding hex levels to a map at different hex scales. This can either be done manually or can be automated using computer software. Variable Map Scaling is map scaling using variable micro-hex ratios between the hex levels, rather than fixed ratios between each adjacent hex level. With fixed micro-hex ratios, the ratio between a parent hex and all the micro-hexes it owns is fixed. With variable scaling this ratio can vary depending upon parameters specified by the map creator, map viewer, map user, or software or other application using the method. Free Map Scaling is similar to variable scaling but removes the need for micro-hex ratios to be expressed as a factor of “1”, thus allowing infinitely variable scale map views. Free map scaling requires different algorithms for the ownership of overlapping hexes.

Grid overlays can be used within the Multi-Level Hex Mapping Method for a range of purposes. These purposes include but are not limited to:
(a) Relating hex based maps to cartographic grid systems such as the British National Grid and UTM systems, as well as latitude and longitude references.
(b) Mapping the surface of the earth or any other spheroid and applying one of the standard cartographic projection methods for catering for the curved surface of the earth, such as the Transverse Mercator Projection.
(c) Relating to or interfacing with cadastral mapping systems.
(d) Relating to or interfacing with vector or raster based spatial information systems.
(e) Assisting in the use of identifying locations by place names or other identifiers where those identifiers are best accessed via the coordinates of a grid system.
(f) Converting hex maps from one hex scale to another.
(g) Providing alternate location reference methods for a variety of purposes, including mapping the movement of objects that are not affected by terrain, or are required to move in straight lines, curves or other manners independent of hexes, and calculating such movements.
   These various uses of grid overlays as part of the Multi-Level Hex Mapping Method are discussed below.

Multi-level hex maps can be cross-referenced to conventional maps, which use a range of grid systems to identify locations. These systems include the latitude and longitude WGS 84 and UTM systems, and the British National Grid. By applying these grids to a hex map, or cross-referencing one or more of these grids to a hex map grid overlay, as shown in FIG. 13 for example, locations identified in these systems can be identified in a hex map.

Conventional grid systems and hex mapping systems map flat surfaces (leaving aside topographic elevation mapping through the use of contour lines), but the surface of the earth is not flat. Thus maps of the earth's surface using a grid system of parallel lines contain some level of inherent error based on the curvature of the earth. The extent of such errors is a function of the scale of the map. There are various cartographic methods for projecting the curved surface of the earth onto a flat map, including the Mercator, Transverse Mercator, Lambert Conformal methods and others. These same methods can be applied to Grid Overlays in the Multi-Level Hex Mapping method. The projection method best suited to the intended application of the map should be used.

It should be noted that these projection methods relate to grid overlays, and can therefore relate to hex maps using grid overlays through the relationship between the grid overlay and the hex map. Alternately, another method for allowing hexes to map the curved surface of the earth or any other spheroid surface is discussed later in this document under the heading “Curved Surface Hex Mapping.”

Hex map grid overlays may be used to interface to or cross-reference locations in cadastral or other types of spatial information systems. A common reference point for the grids on both systems needs to be identified, and grid scales and location identifiers converted such that the location identifier of one system can be converted to a location identifier on the other system. This method can also allow the cross-referencing of or access to location data across both systems.

Location identifiers in hex maps can be cross referenced to grid references in non-hex maps through the grid references of hex map grid overlays, as exemplified in FIG. 13, and conversion mechanisms developed to automate these conversions. This also applies to identifying locations by their common name, and correlating and cross-referencing hex and non-hex maps through the use of such names.

Grid overlays may utilise grid scales that are the same as or different to non-hex maps. In the situation where grid overlay scales are different from grid scales used in other maps that the map creator wishes to relate to or interface to the hex map or multi-level hex map, the map creator can use a conversion formula to convert grid scales from one type of map to the other and vice versa.

Ground-based objects with an ability to move generally have this ability affected by the type of terrain they are moving through. For example, a vehicle can mover faster along a sealed road than it can over open terrain without a road, and may not be able to move at all through certain types of terrain such as forest or water.

Objects moving over a hex-based map traditionally move from one hex to the next, and follow a path between two hexes by moving progressively from the start hex through progressive hexes until an end-point hex is reached. Depending upon the relative location of the start and end-point hexes, the path followed by a moving object will often not be along a straight line due to the manner in which hexes interconnect, even though in real life the object may move in a straight line between the two locations represented by the start and end-point hexes. Thus hex based maps do not lend themselves to consistent straight line movement in different directions, nor do they lend themselves to movement in smooth curves, such as aircraft or ships would generally move along when changing direction.

The Multi-Level Hex Mapping method includes the option of overlaying traditional square or cube grids over the hex map. Grid overlays can be either two or three dimensional, but the plane formed by two of the dimensions should be parallel to a plane formed within a hex map by hexes with the same hex elevation. Locations on these grid overlays are defined by the intersection of any two lines on the grid if the grid is two dimensional, or the intersection of any three lines if the grid is three dimensional.

These grid overlays can be used to map movement of objects that are not affected by ground surface terrain type in their movement and for other purposes. By use of such overlays, movement of objects not affected by surface terrain can be mapped in straight lines between two grid points, or along curves defined by a series of grid points. The resolution of these curved lines of movement is dependent upon the grid scale utilised. It should be noted that straight line or curved line movement could be approximated in a hex map with the resolution of the line of movement again being dependent upon the hex scale utilised. The manner in which traditional hex maps are normally viewed generally creates an unacceptable result, although this could be made acceptable for certain applications using the Multi-Level Hex Mapping Method by having a large enough micro-hex ratio between the hex level used for viewing such movement and the micro-hex level used to resolve such movement.

Grid scales for grid overlays may vary across a hex map, even at the same level within the map. Different grid overlays may be used at different map levels, or different layers within a map level.

When a grid overlay is used in conjunction with a multi-level hex map, the grid scale may be different from any of the hex scales used. Depending upon the application for which the map is being used, it may be preferable for simplicity to have the grid scale the same as the smallest scale micro-hexes used within the map. This enables any grid location to be correlated with a unique micro-hex at the smallest scale micro-hex level within the hex map and vice versa.

However, if object movement and location tracking needs to be finer for objects that move in the grid overlay (e.g., aircraft or ships), then a smaller scale may be used for the grid overlay than for lowest hex level within the map. When grid overlay scales are smaller than the smallest hex scale in the same map, it is preferable that the smallest hex scale be a whole number multiple of the smallest grid scale used in the map.

The hex-grid overlay ratio (or hex-grid ratio) at any map location and level is the ratio between the hex scale and the grid scale at that location and level. For example, FIG. 13 shows a hex-grid ratio of 1:1, while FIG. 14 shows a hex-grid ratio of 2:1.

Grid overlays should be linked to a multi-level hex map such that each point on the grid can be correlated to a hex in the hex grid. Thus a location on the hex map defines a location or locations on a grid overlay, and likewise any grid overlay location also defines a location on the hex map. To facilitate this location relationship, it is preferable that grid locations be such that no grid location falls on the boundary of a hex. Two examples of this are shown in FIGS. 13 and 14.

As illustrated in FIG. 13, it should be noted that each of grid locations 120, being points, will always correlate to a single hex location, being an area, at a given map level (given that grid locations do not coincide with hex boundaries). However, one hex location may correlate to several grid locations if the area of the hex covers more than one grid location, as shown in FIG. 14. The latter will occur when the grid scale is smaller than the hex scale. In such cases, an algorithm is required to select the unique grid location if a hex location needs to correlate to a unique grid location. A simple algorithm would be to select the upper left grid point from all grid points located within the hex.

As shown in FIG. 15, when hexes are drawn such that all edges and radials of the hex are the same length (referred to as the standard hex aspect ratio), with hexes oriented in the preferred manner with a hex edge uppermost, the horizontal distance 29 between two vertical lines joining the centre points of two adjacent columns of hexes is less than the vertical distance 22 between two opposite edges on a single hex.

With reference to FIG. 13, in this diagram both the hex scale and the grid scale are 50 metres, and thus there is one vertical grid line 121 for every vertical hex column 122 and one horizontal grid line 123 for every hex within a single vertical column. The hexes are drawn using the standard hex aspect ratio. But if you look at the grid overlay as it appears on the map, the horizontal distance between the vertical grid lines is less than the vertical distance between the horizontal grid lines. This is due to the difference between the horizontal distance between the vertical grid lines (that run through the centre points of the hexes within each hex column) and vertical distance across each hex, as described in the previous paragraph.

Thus when a grid overlay is used with a hex map using the standard hex aspect ratio, whilst the distance on the surface being mapped is the same between each adjacent grid line for both vertical and horizontal grid lines (50 metres for the example shown in FIG. 13), the actual distance on the map between adjacent vertical grid lines is less than the same distance between adjacent horizontal grid lines. The ratio between these latter distances is referred to as the Hex Based Grid Overlay Aspect Ratio, as it is the ratio required to have the same grid scale on the horizontal and vertical grid axes with the grid overlay mapping to the hex map using the standard hex aspect ratio for the hexes.

Alternately, it is possible to have the grid lines form squares (referred to as the standard grid aspect ratio) and still have the grid overlay map to the hex map by changing the hex aspect ratio. FIG. 16 shows an example of this. A hex aspect ratio allowing the mapping of a hex map to grid overlay using the standard grid aspect ratio is called a Grid Overlay Based Hex Aspect Ratio. FIG. 17 shows the grid overlay based hex aspect ratio that is used to form the hex map in FIG. 16. In general, map creators using hex based maps with grid overlays should use the aspect ratios best suited to their application.

As discussed above, conventional maps and grid overlays can be used to map curved surfaces such as the surface of the earth, using a range of alternate cartographic projection methods to compensate for the surface curvature. Alternately, within the Multi-Level Hex Mapping Method, hex maps may be used to map curved surfaces, including the curved surface of the earth. One such algorithm for doing so is described below, but firstly some terminology and concepts need to be addressed.

If you refer to FIG. 15, which shows the standard hex aspect ratio, the distances between points AB, CD, and EF (29, 22, and 27, respectively) all represent the hex scale. In a standard hex map, if the hex scale is say 100 metres, the distances 29 and 22 both represent a distance of 100 metres, as does the distance 27.

Variable Hex Scaling allows the vertical scale distance covered by a hex to differ from the lateral or horizontal scale distance covered by a hex and from the angled hex scale distance. For example, in FIG. 15, the distance 22 may have a scale of 100 metres and thus represent 100 metres on the surface being mapped (e.g., the earth), whilst the distance 29 may have a scale of 80 metres and thus represent 80 metres on the surface being mapped. The distance 27 could have yet another scale (e.g. 90 metres) or the same scale as distance 29, depending upon the needs of the map creator. This should not be confused with the hex aspect ratio, which is the shape of the hex and how it appears on the map.

Still referring to FIG. 15, the distance 22 is referred to as the Vertical Hex Scale, the distance 29 is referred to as the Horizontal Hex Scale, and the distance 27 is referred to as the Angled Hex Scale, where these distances are expressed as distances on the surface being mapped.

The use of variable hex scaling enables curved surfaces to be mapped using hex maps within the Multi-Level Hex Mapping Method, including the mapping of surfaces such as the surface of the earth. A multi-level hex map needs to use an algorithm to determine the different hex scales within a level of the map to map such a surface. One example of such an algorithm is provided below.

The Spheroid Hex Mapping Algorithm uses latitude and longitude references to map the surface of the earth using a hex map. The algorithm is:
(a) The vertical hex scale is constant across the map, irrespective of location.
(b) The horizontal hex scale at the equator is the same as vertical hex scale.
(c) The horizontal hex scale varies as a function of latitude such that the horizontal hex scale progressively decreases form the same as the vertical hex scale at the equator to zero at the poles as the latitude increases from zero at the equator to 90 degrees at the poles. The horizontal hex scale is calculated at any latitude such that it enables a flat hex map to have an accurate horizontal hex scale based on the vertical hex scale, the latitude, and the curvature of the earth's surface.
(d) For convenience, the angled hex scale can be simply defined as the same as the horizontal hex scale as the hex from which it is being measured (i.e., the hex containing centre point E in FIG. 15). Whilst this provides an inherent error in the angled hex scale, for most maps this error is going to be so small as to be irrelevant. However, if the map creator needs to eliminate or reduce this error, an alternate method of calculating the angled hex scale can be used as best suits the needs of the map creator or user.
   This algorithm or method is also referred to as Latitude Hex Scaling. The map creator can develop alternate algorithms if this algorithm does not suit the application for which the map is intended.

The data required by the method should be stored in some form of computer-based data management system when the method is implemented using computer software. This could be a flat file structure, or a relational database management system, or some other suitable type of system. FIG. 18 shows an example of a data structure 140 for use in implementing the method in accordance with one embodiment of the invention. In general, the underlying data may be stored using a data model corresponding to one of many well-known methods. For instance, an object-oriented scheme may be implemented, wherein individual elements comprise objects within an object hierarchy. In another embodiment, a relational data model is used.

Maps within a series of maps should be given unique identifiers, such that computer software or a user of the maps can use the identifiers to determine the relative location of the maps within the series. Location identifiers across different maps within the same series should be such that computer software or a user of the map can readily determine the location from the identifier. Location identifiers across different maps within the same series should be such that a unique identifier that identifies a location on a map still identifies the same location when the map is merged with one or more other maps within the series. Furthermore, location identifiers should be configured such as to assist in the merging of multi-level hex maps.

Multi-level hex maps that map areas on the surface of the earth should have location linkages to latitude and longitude location identifiers such that a latitude and longitude location can be identified on the multi-level hex map, and a location on the multi-level hex map can be identified by its latitude and longitude, and elevation above sea level if this is relevant to the application for which the map is used.

Often map users want to identify a location on a map via its place name rather than a hex reference or grid reference. Place names can be included as either hex data or grid location data such that a map can be searched for a location via its commonly known name. A common use of this would be to locate a town by the map user entering its name. In the case of a software implementation of the Multi-Level Hex Mapping Method, entry of a name could result directly in the display of the location on the map. In the case of a printed map, place names could be stored in a table along with the hex location identifier and or grid overlay reference to enable the user to find the location on the map.

An access key is the information or data by which a map or a location on a map is accessed. These access keys can include map or location names, reference numbers or identifiers, and through the use of grid overlays, can include latitude and longitude references, and other conventional cartographic grid or map references, including such reference systems as the British National Grid. The use of multiple access keys enables users to access multi-level hex maps by a range of reference types.

The Multi-Level Hex Mapping Method includes several methods to aid in the production of maps by the map creator. These methods recognise that map production within the Multi-Level Hex Mapping System can be on ongoing process such that initial maps can be created and used, with the initial maps being expanded over time both in their coverage and the type, level and amount of data and information detail they contain.

Map skeletons are multi-level hex maps that contain no terrain information or other data. They contain just the information necessary for the hexes (and grid overlays if they are used) to be viewed. Referring to the data structure diagram 140 in FIG. 18, this would include the hex layout data 142, map data 144 and map grid data 146 (i.e., the top three data sets in the diagram), and the following hex data: hex identifier, type, scale, location, and immediate parent hex (i.e., the top five data items of the data set entitled “Hexes” 148). It may also include layered and subsequent hex information if the map creator chooses to include such hex types in the skeleton.

Skeletons can then be progressively “filled in” or expanded by the map creator, with expansion potentially including the addition of more hex data, increase in the area covered by the map, increase in the number of levels in the map, the addition of layered and/or subsequent hexes, and the addition of grid overlays or terrain summary information or terrain detail information, or alternate location reference data. Terrain derivation methods as discussed above provide a further aid to the map creator and may assist in fleshing out a map skeleton. Skeletons containing only partial information, such as having only a portion of the hexes assigned a terrain type, are referred to as Partial Skeletons.

Additional techniques may be employed to control various aspects of a map or set of maps. For example, map merging is the process of joining two or more multi-level hex maps into one larger map. Map merging may be automated by computer software used to implement the Multi-Level Hex Mapping Method. Map segmenting is the process of dividing a multi-level hex map into two or more smaller maps. Map segmenting may also be automated by computer software used to implement the Multi-Level Hex Mapping Method.

The use of such progressive production of maps will allow the map creator to increase the level of information available from the map whilst users or computer application software commence using the map as soon as sufficient information is available to meet the user's needs or the needs of the computer application software.

As discussed above, the principles of the Multi-Level Hex Mapping Method are best realized when implemented via computer software. The use of computer software may be applicable to both the design and rendering phases of map usage. For example, a computer software implementation is required when applying the method for video games, military simulation, and the like.

According to one embodiment, the Multi-Level Hex Mapping Method may be implemented in an interactive map generation software application. Under the application, a map designer is enabled to design a map using selected hex scales, micro-hex associations, and mapping attributes. In one implementation, digital mapping data may be extracted from an existing map, such as a contour map or satellite photography map, and inserted into a new map that is designed using the software application. This enables very accurate modeling within the map or sets of maps being designed.

Some details of an exemplary map generation sequence are shown in FIGS. 19a-e. Each of FIGS. 19a-e shows a user interface for an exemplary computer software implementation of the Multi-Level Hex Mapping Method. The user interface provides a graphical means for interacting with the underlying software, which includes interfaces for storing data in and retrieving data from data structure 140 of FIG. 18.

The design process begins in FIG. 19a, wherein a new design file has been opened, and a blank map 200 is displayed. Although shown has a rectangle, the mapping method may be applied to maps of various shapes, as discussed above. A first operation involves populating the map (or a portion of the map) with base hexes. In the illustrated embodiment, the user selects a series of menu options via pull down menus 202 and 204 off of an “INSERT” menu option, the later of which includes various hex scale choices. In further detail, the user selects an “ADD ATTRIBUTES” option from pull down menu 202 and then selects a 100 M scale from pull down menu 204. As another option, the user can chose to launch a dialog box into which the hex scale for the base hexes is entered.

In response to the user action, data corresponding to the base hex parameters are added to data structure 140. In particular, appropriate data are added to hex layout data 142, map data 144, and hexes data 148. The data define the location, orientation, and hex scale of each of the added hexes. Additional information, such as elevation, may also be added, if appropriate. Immediately thereafter, the new mapping data are rendered to produce the map display of FIG. 19b, which now contains a plurality of base hexes 210. Further details of the rendering operation are described below.

In addition to various menu options, the software application enables the map builder to zoom and pan around the map being designed. For example, FIG. 19b shows a zoom operation that is initiated by a user clicking and dragging a cursor input to create a selection box 212. Zooming on the selection box 212 results in the map display shown in FIG. 19C.

At this point, the user selects one (shown) or more base hexes 210 to add micro-hexes to. It is noted that as far as the system knows, any level of hex is a candidate for adding further hex granularity to. In the illustrated example the user clicks on a base hex 210A to start a micro-hex addition process. In one embodiment, the software application is context-aware, and presents appropriate context menus to the user in response to the current map or edit context. For example, in the illustrated embodiment, the user has “right-clicked” on base hex 210A, which brings up a context menu 214 containing a list of options that are applicable to editing a selected hex or hexes. Among other options, the options include “ADD MICRO HEXES”, “ADD ATTRIBUTES”, “CHANGE HEX RATIO” (currently grayed out, since no micro-hexes exist), and “ADD SUBSEQUENT HEX.” In this instance, the user selects the “ADD MICRO HEXES” option, which brings up a second context menu 216 containing a list of micro-hex ratios. The user then selects the “ADD 5:1” option, indicating the user wishes to define base hex 210A to contain micro-hexes have a scale that is ⅕ the scale of base hex 210A.

The result of this operation is shown in FIG. 19D, which now includes a plurality of micro-hexes 218. As before, appropriate data are added to data structure 140 prior to rendering the display of FIG. 19D. In particular, data relating to spatial relationship, ownership, hex aspect, scale, and orientation is added. The layout and configuration of the micro-hexes will be determined as a function of the selected hex-ratio and the applicable spatial relationship and ownership algorithms.

Another aspect of the software application is the ability to associate mapping attributes with respective hexes or groups of hexes. For example, hexes may be associated with terrain data, elevation data, and various types of attributes, such as roads, bridges, rivers, buildings, etc.

FIG. 19e shows a icon-based mapping attribute menu 220, which contains an exemplary set of attributes that may be added a selected hex or hexes. In the illustrated example, these attributes include terrain elements, such as a river 222, a lake 224, and a tree 226 (representing forested terrain), transportation route-type elements, such as a bridge 228, a roadway 230, and a railway 232, and structure elements, such as a building 234. The map creator may assign or associate a mapping element selected hexes via one of several known means. For example, in the illustrated embodiment, the user selects hexes 218A, 218B, 218C, and 218D, and then drags and drops railway 232 over one of the selected hexes. The net result, is that a railway attribute is now associated with hexes 218A, 218B, 218C, and 218D. In response to the addition of the railway attribute, corresponding information is added to data structure 140 to reflect the addition of the element, and the association between the element and hexes 218A, 218B, 218C, and 218D.

As discussed above, mapping attributes, such as terrain types, may be added to various levels of hexes, including hexes occupying the same location. For example, a parent hex may be assigned a terrain type of “forests”, while individual micro-hexes for the parent hex may be assigned different attributes, such as attributes identifying rivers, or transportation routes. One of the benefits of adding this further level of detail is that rendering operations and efficiency are improved. For example, only details corresponding to the higher level terrain attributes might be displayed when a portion of a map was zoomed out, while zooming in on the same portion of the map would cause details defined for the lower level hexes to be rendered.

In further detail, FIG. 20 shows operations performed during rendering, in accordance with one embodiment. The rendering process begins in a block 300, wherein the display datum and view resolution for the rendered display is determined based on the current pan and zoom level. In one embodiment, the map skeleton is mapped to a virtual display that is many times large than the rendered display. For example the virtual display may have a resolution of 50,000×50,000, while the rendered display is 1024×768, or 1240×1080. In another embodiment, the resolution of the virtual display is scaled based on the overall size of the map. The datum refers to a reference point for the display. In one embodiment, the reference point corresponds to the upper left hand corner of the display.

Next, in a block 302 the hexes that may appear in the rendered display are identified in the data structure. In short, this comprises identifying the hexes that have associated mapping attributes that are up for consideration to appear in the rendered display. Hexes that appear “off the page” are eliminated from consideration.”

As delineated by start and end loop blocks 304 and 312, the operations in decision block 306 and blocks 308 and 310 are performed for each hex that is identified in block 304. First, a determination is made in decision block 306 to whether the hex scale for the block is greater than the zoom level. For example, in one embodiment, details of lower-level hexes are not to be rendered if those details would be obscured or would otherwise degrade the rendering process. Thus, it would not be advantageous to render the details. On the other hand, such details are desired to be rendered when the zoom level is such that displaying the details enhance the rendered display.

If the hex scale exceeds the zoom level threshold, renderable elements associated with the hex are retrieved in a block 308. In a corollary operation, the retrieved elements are rendered in block 310 using an appropriate mask or template. The location and scale used to render the mask or template is based on the offset from the datum and the zoom level. For example, forests and other terrain may be rendered at various levels of detail depending on the zoom level. Accordingly, different masks or templates may be employed to render each particular level of detail, or a single mask or template with a corresponding rendering algorithm may be employed.

Also as discussed above, hexes may be assigned various priority levels. This enables display of mapping attributes associated with higher priority level hexes in lieu of attributes associated with lower priority hexes. EXEMPLARY COMPUTER SYSTEM FOR PRACTICING THE INVENTION

With reference to FIG. 21, a generally conventional computer 400 is illustrated, which is suitable for use in running computer software in connection with practicing the present invention, and may be used for running client and server-side software comprising one or more software modules that implement the various operations of the invention discussed above. Examples of computers that may be suitable for client machines as discussed above include PC-class systems operating the Windows NT or Windows 2000 operating systems, Sun workstations operating the UNIX-based Solaris operating system, and various computer architectures that implement LINUX operating systems. Computer 400 is also intended to encompass various server architectures, as well as computers having multiple processors.

Computer 400 includes a processor chassis 402 in which are mounted a floppy disk drive 404, a hard drive 406, a motherboard 408 populated with appropriate integrated circuits including memory 410 and one or more processors (CPUs) 412, and a power supply (not shown), as are generally well known to those of ordinary skill in the art. It will be understood that hard drive 406 may comprise a single unit, or multiple hard drives, and may optionally reside outside of computer 400. A monitor 414 is included for displaying graphics and text generated by software programs and program modules that are run by the computer. A mouse 416 (or other pointing device) may be connected to a serial port (or to a bus port or USB port) on the rear of processor chassis 402, and signals from mouse 416 are conveyed to the motherboard to control a cursor on the display and to select text, menu options, and graphic components displayed on monitor 414 by software programs and modules executing on the computer. In addition, a keyboard 418 is coupled to the motherboard for user entry of text and commands that affect the running of software programs executing on the computer. Computer 400 also includes a network interface card 420 or built-in network adapter for connecting the computer to a computer network, such as a local area network, wide area network, or the Internet.

Computer 400 may also optionally include a compact disk-read only memory (CD-ROM) drive 422 into which a CD-ROM disk may be inserted so that executable files and data on the disk can be read for transfer into the memory and/or into storage on hard drive 406 of computer 400. Other mass memory storage devices such as an optical recorded medium or DVD drive may be included. The machine instructions comprising the software that causes the CPU to implement the functions of the present invention that have been discussed above will likely be distributed on floppy disks or CD-ROMs (or other memory media) and stored in the hard drive until loaded into random access memory (RAM) for execution by the CPU. Optionally, all or a portion of the machine instructions may be loaded via a computer network.

For the purposes of the specification, a machine-readable medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-readable medium includes, but is not limited to, recordable/non-recordable media (e.g., a read only memory (ROM), a random access memory (RAM), a magnetic disk storage media, an optical storage media, a flash memory device, etc.). In addition, a machine-readable medium can include propagated signals such as electrical, optical, acoustical or other form of propagated signals (e.g., carrier waves, infrared signals, digital signals, etc.).

It will be appreciated that computer system 400 is one example of many possible computer systems that have different architectures. For example, computer systems that utilize the Microsoft Windows operating system in combination with Intel microprocessors often have multiple buses, one of which may be considered a peripheral bus. Network computers may also be considered as computer systems that may be used with the present invention. Network computers may not include a hard disk or other mass storage, and the executable programs are loaded from a corded or wireless network connection into memory 410 for execution by processor 412. In addition, handheld or palmtop computers, which are sometimes referred to as personal digital assistants (PDAs), may also be considered as computer systems that may be used with the present invention. As with network computers, handheld computers may not include a hard disk or other mass storage, and the executable programs are loaded from a corded or wireless network connection into memory 410 for execution by processor 412.

It will also be appreciated that in one embodiment, computer system 400 is controlled by operating system software that includes a file management system, such as a disk operating system, which is part of the operating system software. For example, one embodiment of the present invention utilizes Microsoft Windows as the operating system for computer system 400. In other embodiments, other operating systems that may also be used with computer system 400 include, but are not limited to, the Apple Macintosh operating system, the Linux operating system, the Microsoft Windows CE operating system, the Unix operating system, the 3Com Palm operating system, or the like.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for generating mapping content, comprising:
defining a first plurality of hexes having a first hex scale;
associating pluralities of micro-hexes with respective ones of the first plurality of hexes, each of the micro-hexes having a second hex scale smaller than the first hex scale; and
enabling mapping attributes to be assigned to selected hexes among the first plurality of hexes and selected micro-hexes among the pluralities of micro-hexes.
